(19) United States
(12) Patent Application Publication
(10) Pub. No.: US 2026/0214532 A1
(43) Pub. Date: Jul. 23, 2026

(54) TIMED DEVICE HANDOVER EVENT REPORTING

(71) Applicant: Oswego Technologies LLC, Columbus, NJ (US)

(72) Inventor: Ali Esswie, Calgary (CA)

(21) Appl. No.: 19/374,338

(22) Filed: Oct. 30, 2025

Related U.S. Application Data
(60) Provisional application No. 63/747,325, filed on Jan. 20, 2025.
(60) Provisional application No. 63/756,326, filed on Feb. 10, 2025.
(60) Provisional application No. 63/774,704, filed on Mar. 19, 2025.

(51) Int. Cl. H04W 36/00

(52) U.S. Cl. CPC H04W 36/0085

(57) ABSTRACT

A method performed by a wireless transmit/receive unit (WTRU) for dynamically performing two-stage artificial intelligence (AI) handover event predictions is disclosed. The method comprises transmitting, to a serving radio access network (RAN) node, local handover information, as part of uplink control information (UCI), including a handover prediction information object and receiving, from the serving RAN node one or more handover event AI prediction configurations. The WTRU may execute a multi-layer AI prediction approach comprising: executing a coarse-grained first prediction to identify potential handover events over a first long prediction period; and executing a fine-grained second prediction to refine the timing and accuracy of the predicted handover events over a second shorter prediction period.

### CROSS REFERENCE TO RELATED APPLICATIONS

This disclosure claims priority from U.S. Provisional Patent Application No. 63/747,325, filed on Jan. 20, 2025, from U.S. Provisional Patent Application No. 63/756,326, filed on Feb. 10, 2025, and from U.S. Provisional Patent Application No. 63/774,704, filed on Mar. 19, 2025, which are all incorporated by reference as if fully set forth herein.

### BACKGROUND

The advent of 5G New Radio (NR) technology has revolutionized cellular networks, offering unprecedented data rates, ultra-reliable low-latency communication (URLLC), and massive machine-type communication (mMTC) capabilities. These advancements enable a wide array of applications, including autonomous vehicles, remote surgery, and augmented reality. However, delivering seamless connectivity across diverse scenarios, such as high-speed vehicular environments and densely populated urban areas, remains a critical challenge. One key requirement for maintaining a high-quality user experience is ensuring seamless handovers between cells, which allows devices to transition between radio access network (RAN) nodes without service disruption. The high density of 5G base stations and the dynamic nature of modern networks further complicate this process, making efficient handover management a cornerstone of 5G performance.

5G handover procedures, while an improvement over earlier generations, still involve complex signaling exchanges between devices and RAN nodes. These signaling rounds typically include measurement reporting, handover decision-making, resource allocation, and command execution. While these steps are necessary to ensure reliable communication, they can introduce significant delays, particularly in high-mobility scenarios or when the network is heavily loaded. Such delays may result in service interruptions, packet loss, or even call drops, undermining the potential of 5G applications. Addressing these challenges requires innovative approaches to reduce handover latency and enhance the reliability of transitions between cells.

Artificial intelligence (AI) and machine learning (ML) have emerged as transformative technologies within the telecommunications domain, offering the potential to optimize network operations and improve user experiences. In the context of 5G handovers, AI/ML can play a pivotal role in enabling predictive and adaptive mechanisms. By leveraging real-time data and historical trends, AI/ML algorithms can anticipate handover requirements and proactively allocate resources, thereby reducing signaling overhead and latency. For instance, predictive handover solutions can analyze factors such as user mobility patterns, signal strength trends, and network congestion to determine the optimal timing and target cell for a handover.

At the RAN node level, AI/ML can enhance decision-making processes by providing insights into network performance and user behavior. This enables RAN nodes to make smarter, more efficient handover decisions, minimizing the risk of service degradation. Similarly, at the device level, AI/ML can enable predictive models that help devices proactively prepare for handovers by pre-fetching necessary resources or adjusting communication parameters. These capabilities not only improve the speed and reliability of handovers but also contribute to better overall resource utilization across the network.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In one exemplary embodiment, a wireless transmit/receive unit (WTRU) transmits device capability information to the serving radio access network (RAN) node as part of uplink control information (UCI). The transmitted information includes a binary indication of the WTRU's capability for AI-powered prediction of handover events, as well as real-time device state parameters such as current CPU utilization, battery level, and thermal conditions in terms of temperature indication. This enables the RAN node to optimize handover prediction configurations and allocate resources efficiently, taking into account real-time device constraints.

In another embodiment, the WTRU receives handover event AI prediction configurations from the RAN node over the downlink radio interface, such as via radio resource control (RRC) or downlink control information (DCI) signaling. These configurations may include a minimum confidence threshold for the local AI model's predictions and a target prediction period, such as the upcoming five time slots, over which handover events are expected. This information guides the WTRU in its prediction tasks and reporting criteria.

An additional embodiment involves the WTRU executing AI model inference for handover event prediction based on inter-cell and/or inter-frequency radio resource management measurements. The WTRU employs a multi-layer prediction approach, where a coarse-grained first prediction layer identifies potential handover events over an extended period, such as minutes or multiple aggregated time slots. This is followed by a fine-grained second prediction layer, which refines the timing and accuracy of the predictions over shorter intervals, such as milliseconds or a few orthogonal frequency-division multiplexing (OFDM) symbols. Predictions are continuously updated as new measurements are obtained, ensuring that the configured target prediction period aligns with network conditions.

In another example embodiment, the WTRU preemptively stops the execution of handover predictions. This includes cases where there is a lack of new measurement samples, such as inter-cell or inter-frequency radio resource management measurements, resulting in insufficient data to support accurate predictions, e.g., the available number of new measurement samples, after the latest prediction instant, is less than a preset threshold. Additionally, the WTRU may halt the AI-powered handover prediction process when the device's real-time conditions exceed predefined thresholds, such as CPU utilization surpassing a configured upper limit or the battery level dropping below a preset minimum, to conserve resources and maintain operational integrity. Furthermore, the WTRU may further discontinue handover predictions when it is configured to revert to standard handover reporting, as per predefined network coverage conditions, such as those specified in 3GPP TS 23.009, ensuring that fallback mechanisms are employed to maintain reliable connectivity and signaling in scenarios where predictive operations are deemed unsuitable or unnecessary.

In another example embodiment, upon executing the first prediction layer, the WTRU determines a preliminary first prediction handover event, including the associated timing period and prediction confidence. The WTRU may also subscribe to cooperative handover prediction device-to-device discovery groups. As part of side-link discovery signaling, the WTRU transmits its capability for sharing handover predictions with neighboring WTRUs, enabling collaborative optimization of handover processes.

In another example embodiment, when one or more in-proximity side-link device groups are active, the WTRU shares its coarse-grained first determined prediction results, such as the predicted handover event, prediction timing period, and confidence level, via side-link control information (SCI). Concurrently, the WTRU receives prediction results or updates from neighboring devices. If the WTRU's real-time conditions, such as temperature or CPU load, exceed preset thresholds, or if the remaining battery level is below a defined limit, the WTRU buffers and time-stamps the received prediction samples until the next execution of the fine-grained second prediction layer. The WTRU may determine a start time and an end time for a potential handover event to occur (e.g., predicted). And as all devices in the group may all be time synchronized to the same RAN node, the timing reference (e.g., a certain start slot) may be common across all devices.

In another example embodiment, during the execution of the second prediction layer, the WTRU integrates received inter-WTRU handover predictions with its own first handover event predictions to calculate and update a refined second prediction handover event. This updated prediction includes the event's second timing period, and confidence level. If no handover event is predicted, or if the prediction confidence falls below the configured threshold, the WTRU erases the latest prediction results and cancels the transmission of the proactive handover prediction report.

A further embodiment involves iterative refinement of handover predictions. The WTRU performs a first handover prediction (i.e., a first indication of a positive handover occurrence), determining a prediction first handover event (i.e., determining the first prediction handover event ID), first handover prediction timing, and first prediction confidence. A subsequent prediction is performed, yielding a refined second prediction handover event, second prediction handover timing, and second prediction confidence level. On condition of the second handover prediction yielding a valid result (i.e., a second prediction confidence beyond a threshold and/or a positively determined second handover event), the WTRU overwrites the first determined prediction with the second prediction handover, second prediction handover timing, and second prediction confidence information as the available prediction handover information. This ensures that the most accurate and up-to-date prediction handover information is utilized before triggering the proactive prediction handover reporting to the serving RAN node.

In another embodiment, the WTRU compiles a cross-WTRU local-area handover prediction information object. This object includes data such as the WTRU's location or a location indication, the determined local area coverage diameter representing the maximum inter-WTRU distance for handover prediction sharing, and one or more inter-WTRU prediction handover event indications. This information is transmitted to the serving RAN node, enabling enhanced management of local-area resource allocation and improving handover prediction accuracy within the group.

In another embodiment, the WTRU measures the distance in terms of an effective local-area coverage diameter, which represents the maximum inter-WTRU distance within the handover prediction sharing group, based on a combination of actual physical distance measurements and signal-based parameters indicative of coverage. This effective distance is derived from inter-WTRU signal strength and coverage levels, such as received signal strength indication (RSSI) or reference signal received power (RSRP), transmitted as part of the cooperative side-link discovery signaling. The WTRU incorporates the detected coverage levels of other WTRUs within the group to estimate the relative proximity distance based on the proportionality between received coverage level versus physical distance.

In a final embodiment of the WTRU, when the WTRU predicts a handover event with a calculated prediction confidence above the configured threshold and a predicted handover event timing within the target prediction period, it proactively reports the available prediction handover information to the serving RAN node. This report may include the handover event indication, the prediction period with a start slot index and the number of upcoming slots for which the prediction is valid, and the target RAN node ID where the handover is expected to occur. Such proactive reporting enhances the efficiency and reliability of handover operations, ensuring seamless connectivity in 5G networks.

In one embodiment of the radio access network (RAN) node, RAN node is configured to receive, over the uplink radio interface, device capability information from user equipment (UE). This information includes a binary indication specifying whether the device supports AI-powered handover event prediction. The RAN node uses this information to identify UEs capable of leveraging advanced predictive models for handover events, enabling tailored configuration and optimization of network resources.

In another embodiment, the RAN node transmits handover event AI prediction configurations to capable UEs over the downlink radio interface. These configurations include one or more information elements, such as a minimum AI model confidence threshold, defining the required accuracy for the UE to trigger proactive reporting of predicted handover events and an initial prediction period, specifying the near-future time window during which a handover event is expected to occur. For example, the RAN node may instruct a UE to report predictions for handover events expected within the next 5 slots starting from slot x.

In another embodiment, the WTRU utilizes uplink control resources, such as physical uplink control channel (PUCCH) or physical uplink shared channel (PUSCH), to report handover event predictions to the serving RAN node. In the event that the WTRU is simultaneously handling ultra-reliable low-latency communication (URLLC) and/or higher priority traffic that conflicts with these resources, the WTRU prioritizes URLLC traffic transmission to meet its stringent latency and reliability requirements, as mandated by system specifications. To resolve intra-WTRU resource conflicts between reporting handover predictions and URLLC traffic, the WTRU halts the transmission of the handover prediction report until the next available PUCCH or PUSCH resource opportunity over which there is no resource conflict with pending URLLC traffic.

In another embodiment, the WTRU buffers the available handover prediction reports when there is a resource conflict with URLLC and/or higher priority traffic, postponing transmission until the next available PUCCH or PUSCH resource opportunity. While the report is buffered, the WTRU assesses the remaining time before the predicted handover event (i.e., due to halting of report transmission) is expected to occur. If this remaining time falls below the target configured prediction period as configured by the RAN node, the WTRU determines that the prediction is too close to the expected handover event to be useful for the RAN node (i.e., the RAN node may not have tolerable period to handle resource allocation before the predicted handover event to occur) and permanently cancels the transmission of the handover prediction report. In this scenario, the RAN node relies on standard measurement reports, such as signal strength or quality indicators from WTRUs, to make decisions regarding the device's handover, as the predictive information is no longer available for proactive action.

In another embodiment, the RAN node receives, over the uplink control channel, a proactive handover event prediction report from a UE. The report includes: a handover event indication, identifying the predicted handover event, and, a handover prediction period, detailing the start slot index and the number of subsequent slots for which the prediction is valid, based on the UE's configured minimum AI confidence threshold, and, the target RAN node ID, indicating the node to which the UE predicts the handover may occur.

In another embodiment, on receiving a proactive handover event prediction report, the RAN node calculates the remaining delay budgets for packets buffered for transmission to the reporting UE. The RAN node identifies the latency-critical packets with delay budgets that fall within the reported handover prediction period. It prioritizes the scheduling and transmission of these packets during the time preceding the reported start of the prediction period. This approach ensures timely packet delivery while minimizing disruptions caused by the predicted handover. The RAN node may instantly change its current scheduling policies not based on radio conditions of fairness, but based on received handover prediction reports from one or more WTRUs.

In another embodiment, upon identifying a valid handover prediction report from a UE, the RAN node initiates handover request procedures towards the reported target RAN node using the backhaul or XN interface. This proactive triggering of handover requests ensures that the target node is prepared to receive the transitioning UE. By leveraging the UE's predictive reporting, the RAN node reduces handover delays and enhances overall network efficiency.

In this embodiment, the RAN node dynamically adjusts the AI prediction configurations based on network conditions and feedback from UEs. For instance, if a significant number of UEs report handover predictions with confidence levels exceeding the configured minimum threshold, the RAN node may reduce the confidence threshold or extend the prediction period to capture additional events. These adjustments optimize resource allocation while maintaining prediction reliability.

In this embodiment, the RAN node coordinates with neighboring RAN nodes over the XN interface to enhance predictive handover accuracy. On receiving proactive handover predictions from multiple UEs indicating a common target RAN node, the serving RAN node exchanges prediction information with the target node. This collaboration facilitates pre-allocation of resources at the target node, ensuring a seamless transition for UEs during the predicted handover period.

### BRIEF DESCRIPTION OF THE DRAWINGS

FIG. 1 illustrates the cross-WTRU local-area handover prediction information signaling and handover group formation;

FIG. 2 illustrates a timeline of the proposed device action;

FIG. 3 illustrates a flow diagram of the WTRU executing the two-stage handover prediction and reporting;

FIG. 4 illustrates a timeline of the RAN node radio resource scheduling actions based on received prediction handover reports;

FIG. 5 illustrates the difference of device action for compiling and transmitting the proactive prediction handover report in TDD and FDD networks;

FIG. 6 illustrates options for delivery of the AI model information as RAN-agnostic or RAN-native delivery;

FIG. 7 illustrates AI model metadata delivery options;

FIG. 8 illustrates the WTRU-RAN bidirectional signaling of the AI capability information and corresponding AI provisioning rules;

FIG. 9 illustrates the WTRU behavior for executing an AI model inference, checking both the RAN-specific and AI-model triggers;

FIG. 10 illustrates the priority-based primary and secondary AI model maps of the WTRU;

FIG. 11 illustrates the sequential WTRU steps before a RADIO AI model inference is executed;

FIG. 12 illustrates a timeline of the WTRU for executing provisioned RADIO AI models;

FIG. 13 illustrates the WTRU device action for triggering the uplink transmission of an AI PDU set;

FIG. 14 illustrates the uplink PDU control information transmission alongside PDU Set delivery over Uplink data channel;

FIG. 15 illustrates the WTRU device action segmenting buffered AI PDU sets; and

FIG. 16 illustrates the WTRU action detailed timely executing the proposed dynamic AI PDU set compilation and transmission procedure.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications, and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

One of the fundamental requirements of 5G NR is to support seamless handover procedures, which enable user equipment (UE) to transition between cells or frequency layers without service degradation. Unlike previous generations, 5G networks operate with ultra-dense deployments of small cells, leveraging both sub-6 GHZ and millimeter-wave frequency bands. These deployments increase the frequency of handovers, particularly in scenarios involving high-speed users such as passengers in fast-moving vehicles. Ensuring smooth transitions in such environments is critical to maintaining quality of service (QoS) and user experience.

Handover procedures in existing wireless communication systems, such as those defined by 3GPP standards, face significant limitations in supporting high-mobility scenarios. The current handover mechanism relies on a reactive process wherein user devices (UEs) measure and report coverage metrics, such as signal strength or quality, to the serving radio access network (RAN) node. Based on these reports, the RAN node processes the measurements, makes a handover decision, and subsequently transmits handover commands to the devices. This multi-step process incurs considerable signaling overhead and latency, which can degrade performance in high-mobility scenarios, such as those involving vehicles or trains, where timely and seamless connectivity is critical.

As on-device artificial intelligence (AI) capabilities become increasingly available and support of 3GPP specs is inevitable for 6G systems (as multiple 3GPP study items on AI and on-device AI are already agreed and scheduled for next year towards 6G), there is an opportunity to leverage these capabilities to proactively assist in the handover process. Devices equipped with AI can perform real-time analysis of coverage conditions and predict handover events, thereby reducing the reliance on traditional reactive reporting mechanisms. By enabling devices to carefully and in a controlled way, provide proactive handover predictions, signaling overhead can be minimized, and latency reduced.

However, the current handover framework is not designed to incorporate AI-powered device predictions. Existing systems lack mechanisms for configuring devices with AI prediction parameters, validating the accuracy of device-generated predictions, and effectively integrating these predictions into the handover decision-making process. This gap necessitates modifications to the handover procedure to support AI-capable devices, allowing for proactive and efficient handover processes while maintaining compatibility with existing network operations.

This patent introduces an AI-driven handover prediction framework where a wireless transmit/receive unit (WTRU) transmits device capability information, including its ability to perform AI-powered handover predictions and real-time resource constraints (e.g., CPU utilization, battery, and thermal conditions), to its serving radio access network (RAN) node. The RAN node configures the WTRU with AI prediction parameters, such as confidence thresholds and target prediction periods, enabling multi-layer prediction processes that combine coarse-grained long-term forecasts with fine-grained short-term refinements. Leveraging side-link communications, the WTRU collaborates with neighboring devices to share and refine prediction data while adapting to its own resource limitations. The WTRU proactively reports high-confidence handover predictions, including event timing and target RAN node identifiers, to the serving RAN node, facilitating efficient resource allocation and reduced signaling overhead in high-mobility scenarios.

In an example, a wireless transmit/receive unit (WTRU) may transmit local handover information to a serving radio access network (RAN) node as part of uplink control information (UCI). RAN node may be a traditional base station or a NTN base station (or any base station for that matter, fixed or mobile). This step forms a foundational element in the method of dynamically performing two-stage artificial intelligence (AI) handover event predictions. The figure depicts the WTRU initiating communication by transmitting detailed local handover information, enabling the RAN node to optimize handover management and prediction configurations.

TABLE 1
Local handover information

| | Local handover information |
|---|---|
| Information | (a) A binary indication of device capability for AI-powered |
| element 1 | prediction of one or more handover events |
| Information | (b) Current CPU utilization, battery level, and thermal |
| element 2 | conditions represented as a temperature indication |

Table 1 illustrates the local handover information message includes a binary indication of the WTRU's capability to perform AI-powered prediction of handover events. This binary signal informs the RAN node whether the WTRU is equipped with the necessary computational and algorithmic resources to execute advanced prediction models. Alongside this, the WTRU reports its real-time operational metrics, which are crucial for assessing its current capability to undertake prediction tasks. These metrics include the WTRU's CPU utilization, which indicates the processing load; the battery level, which reflects the energy available for executing computationally intensive tasks; and the thermal conditions, represented as a temperature indication, to monitor device heat levels and ensure operational stability during prediction processing.

The transmission process is adaptive and context-aware. The WTRU continuously evaluates its real-time conditions, such as CPU utilization and thermal state, to ensure that the transmitted information is accurate and reflective of its current capacity to execute AI-powered handover predictions. This dynamic communication between the WTRU and the RAN node establishes a robust framework for seamless and efficient mobility management in next-generation wireless networks.

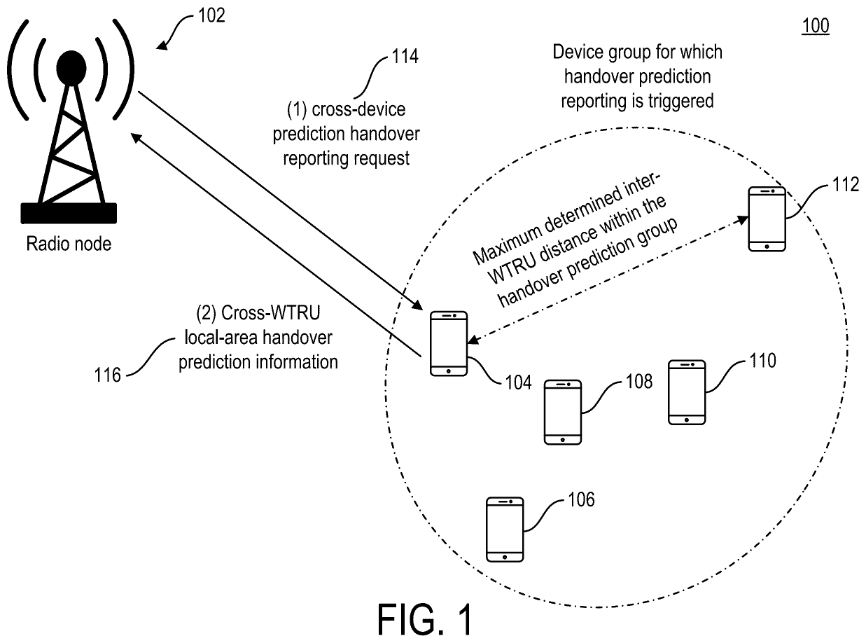

FIG. 1 illustrates a radio access (RAN) 102 and a plurality of WTRUs 104-112. Specifically, FIG. 1 illustrates a signaling procedure 100 by which the RAN node 102 requests a cross-device prediction handover report 114 from a wireless transmit/receive unit (WTRU) 104 and how the WTRU 104 responds by first determining side-link group information and secondly by transmitting a cross-WTRU local-area handover prediction information object 116. This process forms a vital component of the method for enabling dynamic two-stage artificial intelligence (AI) handover event predictions, particularly in scenarios requiring cooperative prediction among devices in a local area. Such aggregate reporting assists the RAN node 102 to train its own AI models by the expected handover event prediction samples of a group of devices that are in proximity of each other, helping it with coming with a geography map that maps certain areas to certain handover events.

Here it is assumed that devices may be handed over individually. Device group handover may be applied when a group of device are on board of a high speed train, etc. In the case shown, despite that various devices in the group may determine a positive handover event coming, they still may end by determining different actual handover events (or types).

The figure depicts the RAN node issuing a request for a cross-device prediction handover report via downlink signaling. This request prompts the WTRU to evaluate its current state and compile detailed local-area prediction information. In response, the WTRU performs several calculations and data aggregation steps to generate a cross-WTRU local-area handover prediction information object. This object includes essential data to support the RAN node in optimizing handover processes and resource allocations.

As part of this process, the WTRU determines the composition of its side-link group, identifying neighboring WTRUs within communication range that participate in cooperative handover predictions. The WTRU calculates the maximum side-link distance to any device in this group, which represents the farthest distance within which reliable prediction data sharing occurs. This distance defines the local-area coverage diameter and ensures that the group remains spatially cohesive for effective prediction sharing. Additionally, the WTRU analyzes received first prediction samples from neighboring WTRUs, which may include predicted handover events, timing periods, and confidence levels. These samples are buffered and time-location stamped by the WTRU, particularly under conditions where its own device constraints-such as high CPU utilization, low battery level, or elevated thermal conditions-limit its ability to perform real-time second handover prediction process. This ensures that critical prediction data is preserved for future processing and/or for direct assistance signaling towards the serving RAN node.

The WTRU compiles the aggregated handover prediction samples into the cross-WTRU local-area handover prediction information object. This object includes the WTRU's own location information or a timestamped location stamp (i.e., in case of high mobility conditions), allowing the RAN node to correlate the relayed handover predictions with geographic areas. Furthermore, the object specifies the local-area validity diameter derived from the maximum side-link distance among the WTRU and any other WTRU of the handover prediction group, ensuring that the RAN node can interpret the spatial relevance of the provided prediction data. The object also contains inter-WTRU prediction handover event indications, summarizing predictions shared within the group to facilitate collaborative decision-making.

Upon completing these calculations, the WTRU transmits the compiled prediction information object to the RAN node. This communication enables the RAN node to integrate cross-device prediction data into its handover management processes, optimizing resource allocation, and reducing latency during mobility events.

TABLE 2
Cross-WTRU local-area handover prediction information

| | Cross-WTRU local-area handover |
|---|---|
| | prediction information |
| Information | (a) WTRU location information and/or |
| element 1 | location stamp indication |
| Information | (b) local-area validity diameter or |
| element 2 | diameter level indication |
| Information | Handover event x₁ (WTRU ID y₁), . . . , |
| object 1 | Handover event xᵢ (WTRU ID yᵢ), . . . , |

Table 2 illustrates the message content design of the cross-WTRU local-area handover prediction information the. Once the prediction samples are processed, the WTRU compiles the cross-WTRU local-area handover prediction information object. This object includes the WTRU's own location or a timestamped location indication, allowing the RAN node to align prediction data with its geographic context. The object also incorporates the calculated local-area validity diameter and one or more inter-WTRU prediction handover event indications, which summarize the collective insights derived from the side-link WTRU group. These indications provide the RAN node with a holistic view of potential handover events within the group, enhancing its ability to manage resources proactively.

The final step may involve the WTRU transmitting the compiled information object to the serving RAN node. By delivering this enriched dataset, the WTRU enables the RAN node to integrate cross-device predictive insights into its handover decision-making processes. This collaboration ensures seamless mobility management, particularly in scenarios where high-density networks or dynamic mobility patterns make accurate handover predictions essential.

The WTRU transmits the cross-WTRU local-area handover prediction information object, toward the serving RAN node using uplink control information (UCI) as control data over the physical uplink control channel (PUCCH). For satellite connections, where larger propagation distances may impact the decodability of the report, the WTRU transmits the information object as part of the uplink data channel, specifically the physical uplink shared channel (PUSCH), ensuring enhanced reliability and decoding efficiency. In this case, the transmission of the report is requested and scheduled by the satellite radio node, which allocates sufficient uplink data resources to accommodate the information object. The WTRU ensures that the required resources are reserved by interacting with the satellite node to confirm the allocation of uplink PUSCH resources, enabling timely and reliable delivery of the prediction report in scenarios where satellite communication is used for mobility management in high-latency environments.

TABLE 3
Handover event AI prediction configurations

| | Handover event AI prediction configurations |
|---|---|
| Information element 1 | (a) Minimum local AI model confidence threshold |
| Information element 2 | (b) target prediction period |

Table 3 shows information element(s) sent from a radio node to a WTRU. A radio access network (RAN) node manages handover events by transmitting artificial intelligence (AI)-powered handover event prediction configurations to wireless transmit/receive units (WTRUs). The figure highlights the critical steps in the method where the RAN node provides precise predictive parameters to the WTRU over a downlink radio interface to enable accurate and efficient handover prediction and reporting.

The RAN node sends AI prediction configurations to the WTRU as part of its interaction for managing handover events. These configurations include specific parameters that guide the WTRU's local AI-based handover prediction process. One of the key parameters is the minimum local AI model confidence threshold, which establishes the accuracy level that the WTRU's prediction model should meet or exceed before reporting predicted handover events to the RAN node. This threshold acts as a filter, ensuring that only reliable predictions with a high probability of occurrence are forwarded to the network, reducing false positives and maintaining efficient network operations.

Additionally, the configurations specify an initial prediction period during which the WTRU is expected to monitor and identify potential handover events. This prediction period is defined in terms of time slots, such as the next five slots, and aligns the WTRU's predictive analysis with the temporal requirements of the RAN node. The use of a defined prediction period ensures that the WTRU focuses its computational resources on time-critical scenarios, enhancing the relevance and timeliness of its reports.

The RAN node transmits these configurations using existing signaling protocols, such as radio resource control (RRC) connection setup messages or downlink control information (DCI) messages. These mechanisms are chosen for their efficiency and compatibility with standard network procedures, ensuring minimal signaling overhead while delivering essential configuration data. The integration of these configurations within standard signaling frameworks facilitates seamless communication between the RAN node and the WTRU, allowing for real-time adaptability to dynamic network conditions.

TABLE 4
Proactive handover event prediction report
Proactive handover event prediction report

(a) Handover event indication
(b) Handover prediction period, detailing the
start slot index and the number of
upcoming slots for which the prediction is valid
(c) Target RAN node ID to which the device
predicts the handover will occur

Table 4 describes a proactive handover event prediction report. A signaling procedure of the proactive handover event prediction may comprise the information of Table 4 being sent from a WTRU to a radio node. The method involves the Wireless Transmit/Receive Unit (WTRU) proactively transmitting a handover event prediction report when its associated prediction confidence exceeds a configured threshold. This ensures that reports are only transmitted under conditions of high certainty, reducing unnecessary signaling and improving network efficiency.

The transmitted prediction report contains three essential information elements. First, it includes an indication of the WTRU's predicted handover event, specifying the anticipated network transition. Second, it details a prediction timing period, encompassing the start slot index and the number of valid upcoming slots. This timing data outlines the expected timeframe for the predicted handover event, enabling the network to allocate resources and prioritize actions. Third, the report specifies a target Radio Access Network (RAN) node identifier, which identifies the network node expected to manage the handover.

In time-division duplex (TDD) systems, not all slots are valid for both uplink and downlink transmission due to the inherent switching between downlink, uplink, and flexible slots, which limits the availability of slots for transmitting handover prediction reports and receiving handover commands. To avoid misleading the RAN node, the WTRU determines an initial handover prediction period and subsequently updates it to account for slot availability. Specifically, the WTRU excludes non-valid slots designated for downlink transmissions, over which uplink transmission of the report is not permitted, delays the transmission of the proactive handover report to the first available uplink slot of the active TDD frame, and updates the start slot to the first available upcoming downlink slot. The WTRU then determines the remaining duration of the initial predicted handover period starting from the updated start slot and identifies one or more downlink slot indications during the determined remaining period. The updated handover prediction report transmitted to the RAN node includes the revised start slot index and the identified downlink slot indications. This ensures that if the RAN node acts on the received report, it can transmit the handover command during one of the reported downlink slots, preventing delays that could render the command ineffective due to the proximity of the predicted handover event.

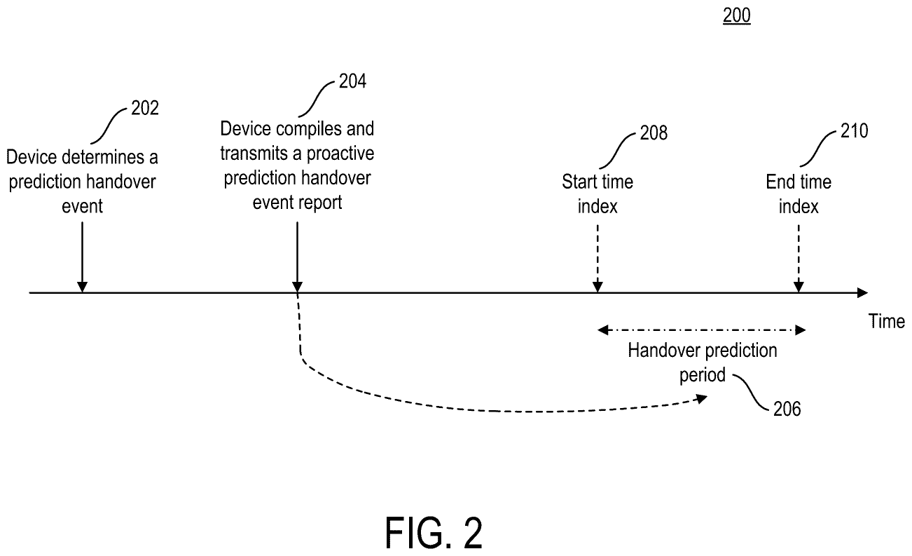

FIG. 2 depicts a timeline 200 of a wireless transmit/receive unit (WTRU) dynamically performing a two-stage artificial intelligence (AI) handover event prediction. The method begins with the WTRU executing a multi-layer AI prediction approach. Initially, the WTRU performs a coarse-grained first prediction over a long prediction period to identify potential handover events. This step provides an early but less precise estimate of handover events. Subsequently, the WTRU performs a fine-grained second prediction over a shorter prediction period. This stage refines the accuracy of the predicted handover event, focusing on both timing and confidence metrics to enhance precision. For example, a first prediction output may be that a handover event may occur within the next 5 minutes starting from a certain time reference. A second prediction may further refine such 5 minutes into a second period from a starting time reference where it overlaps with the first predicted period, allowing the RAN node to get almost a deterministic time point over which the handover is expected.

The WTRU uses the outcomes of these predictions to determine a first handover event, including its timing period and confidence level, based on the coarse-grained first prediction. When the second prediction identifies a more refined handover event with better accuracy, the WTRU updates the previously determined information. It overwrites the first handover event, timing period, and confidence level with those from the second prediction, ensuring the most accurate data is used.

Following the prediction stages, the WTRU assesses whether to transmit a proactive handover event prediction report to the serving RAN node. This decision depends on the prediction's validity, timing alignment within the configured prediction period, and confidence threshold satisfaction. If these conditions are met, the report is compiled and transmitted. The report includes details of the predicted handover event, the prediction timing period (start slot index and number of valid upcoming slots), and the identifier of the target RAN node.

The figure further illustrates the sequential actions of the WTRU, starting with the prediction determination phase. After confirming the validity and confidence of the predicted event, the WTRU transmits the report to the serving RAN node. The timeline progresses with the execution of the predicted handover, where the network transitions the WTRU to the target RAN node based on the report's details. The visualization emphasizes the device's proactive role in optimizing handover processes through AI-driven predictions and reporting.

Specifically, referring to FIG. 2, a WTRU determines 202 a prediction handover event and compiles a prediction handover event report. The WTRU then transmits 204 the proactive prediction handover event report. A handover prediction period 206 is determined, wherein the handover prediction period has a start time 208 and an end time 208.

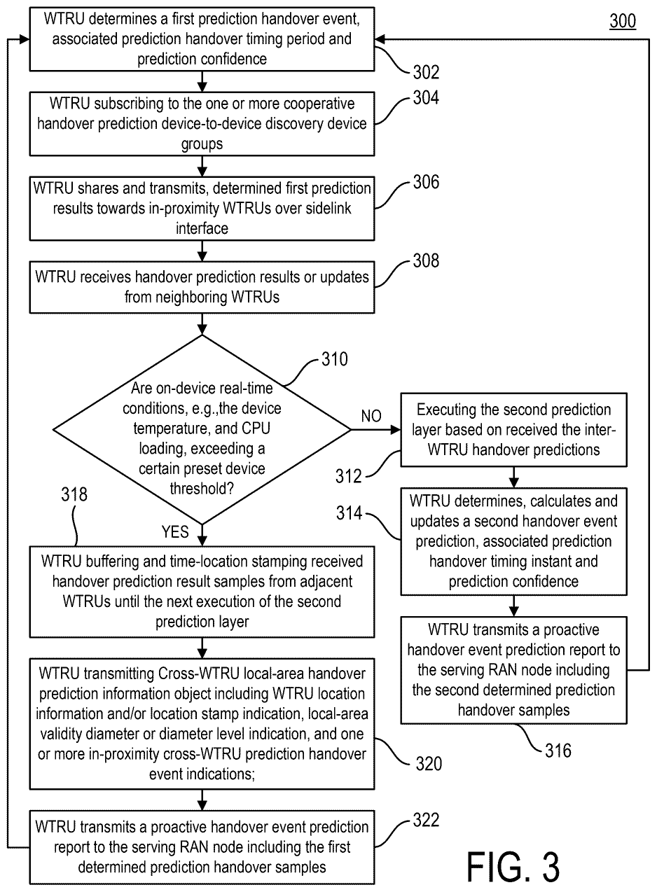

FIG. 3 represents a detailed timing diagram 300 illustrating the sequence of actions performed by a wireless transmit/receive unit (WTRU) for dynamically executing two-stage artificial intelligence (AI) handover event predictions. The diagram highlights the progression from prediction initialization to reporting and eventual handover execution while adhering to multi-layer AI prediction logic.

The process begins with the WTRU transmitting local handover information to the serving radio access network (RAN) node. This uplink control information (UCI) includes critical device parameters such as a binary indication of the device's capability for AI-powered predictions, current CPU utilization, battery levels, thermal conditions, and cross-WTRU local-area prediction data. This data aids the RAN node in understanding the WTRU's current state and readiness for prediction execution. Concurrently, the WTRU receives AI handover event prediction configurations from the RAN node via downlink radio interfaces, such as RRC or DCI signaling. These configurations specify parameters like minimum AI model confidence thresholds and the target prediction period.

Upon receiving the configuration, the WTRU initiates the multi-layer AI prediction process. It first executes a coarse-grained first prediction over a long prediction period, identifying potential handover events with moderate accuracy. If this prediction exceeds a confidence threshold, a fine-grained second prediction is executed over a shorter period to refine timing and event details. The refined prediction updates the handover event, timing period, and confidence level, overwriting the coarse-grained prediction if more accurate.

As shown in the timing diagram, the WTRU determines whether to transmit a proactive handover event prediction report based on predefined conditions. The report is transmitted if a valid handover event is predicted, the prediction timing aligns with the configured period, and the confidence level meets or exceeds the threshold. The report contains the predicted handover event, timing period, and the target RAN node identifier. If any of these conditions are unmet, the report transmission is canceled by the WTRU, and its data is erased.

Following report transmission, the RAN node processes the information and prepares for the handover. At the designated time, the WTRU transitions to the target RAN node, completing the handover process.

Specifically, referring to FIG. 3, the WTRU determines 302 a first prediction handover event, associated prediction handover timing period and prediction confidence. The WTRU subscribes 304 to the one or more cooperative handover prediction device-to-device discovery device groups. The WTRU shares and transmits, determined first prediction results 306 towards in-proximity WTRUs over sidelink interface or by other methods. The WTRU receives 308 handover prediction results or updates from neighboring WTRUs.

The WTRU may determine 310 whether on-device real-time conditions, e.g., the device temperature and CPU loading, exceed a certain device threshold.

If a threshold is not exceeded, the WTRU executes 312 the second prediction layer based on received the inter-WTRU handover predictions. The WTRU determines, calculates and updates a second handover event prediction 314, associated prediction handover timing instant and prediction confidence. The WTRU transmits 316 a proactive handover event prediction report to the serving RAN node including the second determined prediction handover samples.

If threshold(s) are exceeded, the WTRU buffers and time-location stamps received handover prediction result samples 318 from adjacent WTRUs until the next execution of the second prediction layer.

The WTRU transmits 320 a cross-WTRU local-area handover prediction information object including WTRU location information and/or location stamp indication, local-area validity diameter or diameter level indication, and one or more in-proximity cross-WTRU prediction handover event indications. The WTRU transmits 322 a proactive handover event prediction report to the serving RAN node including the first determined prediction handover samples.

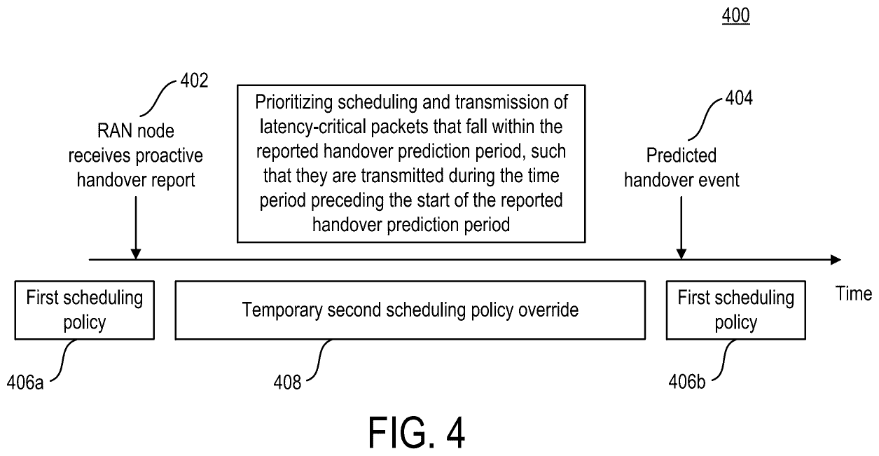

FIG. 4 illustrates the detailed action timeline 400 performed by a radio access network (RAN) node for managing handover events using AI-powered prediction information received from wireless devices. The figure highlights a timing diagram 400 showcasing the interaction between the RAN node and a wireless device (WTRU) as it coordinates prediction, reporting, scheduling, and handover execution.

Specifically, FIG. 4 illustrates a timing-based scheduling strategy implemented by the radio access network (RAN) node to enhance latency-sensitive data transmission in response to a proactively reported handover prediction event. Upon reception of a proactive handover report 402 from the wireless device (WTRU), the RAN node identifies a predicted handover event 404 and applies an adaptive scheduling mechanism. The timeline is divided into three segments. The first 406a and third 406b segments represent the first scheduling policy, which is the default resource allocation behavior. The middle segment 408, aligned with the interval preceding the start of the predicted handover period, reflects a temporary second scheduling policy override. This override is configured to prioritize scheduling and transmission of latency-critical packets that are expected to be at risk of degradation if delayed until or beyond the predicted handover period. The goal is to ensure that such time-sensitive data is transmitted in advance of the predicted interruption window. The three scheduling regions are visually distinguished along the Time axis, corresponding to before, during, and after the predicted handover time range.

The process begins with the RAN node receiving 402 local handover information from the device over the uplink radio interface. This information includes a binary indication of the device's AI-powered prediction capability, as well as real-time device conditions like CPU utilization, battery level, and temperature. Additionally, the uplink data contains cross-WTRU local-area prediction objects, providing contextual data such as WTRU location, local-area validity diameter, and cross-device handover predictions.

Upon receiving this information, the RAN node transmits AI prediction configurations to the WTRU over the downlink radio interface. These configurations specify a minimum AI model confidence threshold for triggering handover event reporting and a prediction period during which handover events are expected. These settings are tailored to network conditions and quality-of-service (QoS) requirements.

As depicted in the timeline, the RAN node then receives 404 a proactive handover event prediction report from the device. This report includes an indication of the predicted handover event, the prediction period (start slot index and duration), and the target RAN node identifier where the handover is expected to occur. Using this information, the RAN node calculates remaining delay budgets for any latency-sensitive packets intended for the device. It prioritizes scheduling and transmits these packets during the period leading up to the predicted handover time to ensure delivery before the transition occurs.

The RAN node simultaneously initiates handover request procedures to the reported target RAN node using backhaul or XN interfaces. These procedures prepare the target RAN node to accommodate the incoming device, ensuring a seamless transition.

As the predicted handover period approaches, the RAN node dynamically adjusts scheduling priorities, overriding existing scheduling policy to prioritize latency-critical packets of the WTRUs of a received proactive handover report. If necessary, it preempts other resource allocations to ensure the WTRU's critical data is transmitted without delay during the predicted transition period.

Throughout this process, the RAN node may also periodically reconfigure prediction parameters for the device based on real-time network load and resource availability. These adjustments optimize the prediction and handover process, maintaining efficiency and QoS adherence.

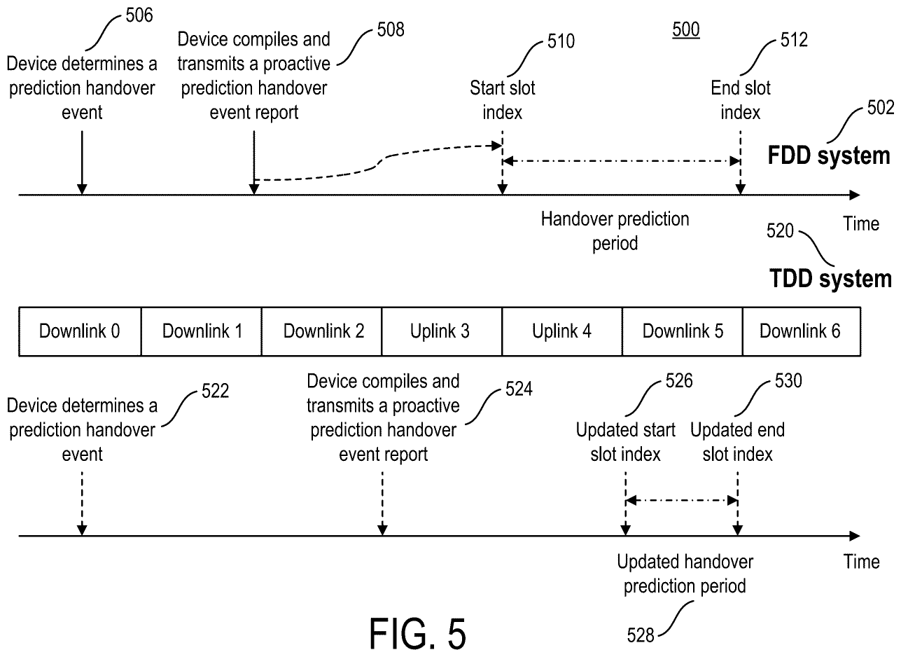

FIG. 5 illustrates an operational comparison 500 of the WTRU operating in both frequency-division duplex (FDD) 502 and time-division duplex (TDD) 520 systems and the differing mechanisms for determining and reporting handover prediction information.

In FDD systems 502, the WTRU determines the handover prediction period based on the output of its handover prediction module without additional slot availability constraints. Because all slots are valid for both uplink and downlink transmissions, the WTRU is able to transmit proactive handover prediction reports to the serving radio access network (RAN) node at any time a valid frequency resource is available. Similarly, the RAN node can send corresponding handover commands to the WTRU without any time slot restrictions. This enables seamless and efficient mobility management in FDD deployments, as the WTRU solely relies on its handover prediction algorithm for reporting and resource coordination.

In contrast, TDD systems impose slot availability constraints due to the alternating nature of uplink, downlink, and flexible slots within the TDD radio frame. The WTRU, in such deployments, should account for these slot restrictions before reporting the timing of its proactive handover predictions to the RAN node (i.e., Assuming the same prediction handover timing information output of the WTRU AI module). The WTRU first identifies the non-valid slots within the initial handover prediction period that are designated for downlink-only transmissions, during which the WTRU cannot transmit proactive handover prediction reports. The WTRU delays the transmission of the proactive handover report to the first available uplink slot and updates the start slot of the handover prediction period to the first valid downlink slot available for transmission.

Additionally, the WTRU calculates the remaining duration of the handover prediction period, starting from the updated uplink slot, and identifies the one or more downlink slots within the remaining duration that are available for the RAN node to transmit a corresponding handover command. This updated timing information is included in the proactive handover prediction report sent by the WTRU, ensuring that the RAN node can act promptly and send the handover command during a valid downlink slot.

The figure further emphasizes that, unlike in FDD systems where seamless communication enables predictive mobility management without timing constraints, the inherent slot restrictions in TDD systems necessitate additional steps for adjusting and optimizing the handover prediction period. These steps ensure that the proactive handover mechanism remains effective by addressing the limitations imposed by TDD radio frame configurations.

Specifically, referring to FIG. 5, a WTRU determines a prediction handover event 506 during a downlink slot. The device then compiles and transmits a proactive prediction handover event report 508. A handover prediction period is defined having a start slot index 510 and an end slot index 512.

In a TDD system 520, the WTRU determines a prediction handover event 522 during DL slot 0. The device compiles and transmits a proactive prediction handover event report 524 at UL slot 3. During DL slot 5, an updated handover prediction period is established 528 having a start slot index 526 and an end slot index 530.

A method performed by a wireless transmit/receive unit (WTRU) for dynamically performing two-stage artificial intelligence (AI) handover event predictions may comprise (a) transmitting, toward a serving radio access network (RAN) node, local handover information, as part of uplink control information (UCI), including: A binary indication of device capability for AI-powered prediction of one or more handover events; and Current CPU utilization, battery level, and thermal conditions represented as a temperature indication; Cross-WTRU local-area handover prediction information object including WTRU location information and/or location stamp indication, local-area validity diameter or diameter level indication, and one or more in-proximity cross-WTRU prediction handover event indications; (b) receiving, from the serving RAN node over a downlink radio interface, handover event AI prediction configurations, including at least one of: A minimum AI model confidence threshold for triggering the reporting of predicted handover events; and A target prediction period for the occurrence of a predicted handover event; (c) executing a multi-layer AI prediction approach comprising: Executing a coarse-grained first prediction to identify potential handover events over a first long prediction period; and Executing a fine-grained second prediction to refine the timing and accuracy of the predicted handover events over a second shorter prediction period; (d) determining, based on a first prediction, a first handover event, associated first handover timing period, and a first prediction confidence level; (e) determining, based on a second prediction, a second handover event, a second handover timing period, and a second prediction confidence level; (f) on condition of determining a second prediction handover event, overwriting the determined first prediction handover event by the determined second prediction handover event, determined first handover timing period with determined second handover timing period and determined first prediction confidence level with determined second prediction confidence level; (g) determining the transmission status of a proactive prediction handover event report to the serving RAN node based on the following conditions: Transmitting the compiled handover report on condition of a valid handover event is predicted, the associated prediction timing does not exceed the configured prediction period, and the prediction confidence meets or exceeds the configured confidence threshold; and Canceling and erasing the compiled handover report when no handover event is predicted, the prediction timing exceeds the configured prediction period, or the prediction confidence is below the configured confidence threshold.

The downlink radio interface includes signaling via radio resource control (RRC) or downlink control information (DCI).

The first prediction period may be longer than the second determined prediction period, measured in multiple aggregated time slots, and the second shorter prediction period is measured in milliseconds or a few orthogonal frequency division multiplexing (OFDM) symbols.

The WTRU may determine delaying or skipping execution of the second prediction layer based on real-time device conditions, including CPU utilization, battery level, and thermal conditions versus preset thresholds.

The WTRU executes the second prediction layer on condition of the coarse-grained first prediction indicates a potential handover event with a confidence level exceeding a preset threshold.

The WTRU subscribing to one or more cooperative handover prediction device-to-device discovery groups to share first handover prediction samples with neighboring WTRUs via side-link signaling.

The WTRU transmits determined first prediction samples, as of a predicted first handover event, handover period, and handover prediction confidence, to neighboring WTRUs using side-link control information (SCI).

The WTRU may receive first handover prediction samples, as of a predicted first handover event, handover period, and handover prediction confidence, from neighboring WTRUs and inputting these result samples into the fine-grained second prediction process.

The WTRU may calculate and determine the maximum side-link distance to a WTRU of the handover side-link group, and from which a first handover prediction sample is received.

The WTRU may buffer and time- and location-stamp received first prediction samples from neighboring WTRUs on condition of on-device conditions, including CPU utilization, battery level, and thermal conditions, exceed predefined thresholds.

The WTRU may compile and transmit towards the serving RAN node, a cross-WTRU local-area handover prediction information object, including WTRU location or location indication information, determined local are coverage diameter (the determined maximum inter-WTRU distance of the handover prediction side-link group), one or more inter-WTRU prediction handover event indications.

The WTRU cancels the transmission of a proactive handover event prediction report if the associated prediction confidence decreases below the configured threshold after initial determination.

The WTRU transmits a proactive handover event prediction report, on condition of the associated prediction confidence is larger than the configured threshold, including An indication of the WTRU predicted handover event; A prediction timing period, including the start slot index and the number of valid upcoming slots; and A target RAN node identifier to which the handover is predicted.

The WTRU, in a time-division duplex (TDD) system, updates the initial handover prediction period by: identifying non-valid slots within the initial prediction period that are designated for downlink-only transmissions, delaying the transmission of the handover prediction report to the first available uplink slot of the active TDD frame, and updating the start slot of the handover prediction period to the first available downlink slot after excluding the non-valid downlink-only slots; determining the remaining duration of the handover prediction period starting from the updated start slot; identifying one or more downlink slots within the determined remaining duration of the prediction period; and including, in the transmitted handover prediction report, the updated start slot index and the identified one or more downlink slots.

A method performed by a radio access network (RAN) node for managing handover events using artificial intelligence (AI)-powered prediction information received from wireless devices, comprising:
(a) receiving, over an uplink radio interface from a device, user equipment (UE) local handover information, including: a binary indication of device capability for AI-powered prediction of one or more handover events; and Current CPU utilization, battery level, and thermal conditions represented as a temperature indication; Cross-WTRU local-area handover prediction information object including WTRU location information and/or location stamp indication, local-area validity diameter or diameter level indication, and one or more in-proximity cross-WTRU prediction handover event indications; (b) transmitting, over a downlink radio interface toward the device, handover event AI prediction configurations, including at least one of: a minimum local AI model confidence threshold to be fulfilled by the device for triggering reporting of predicted handover events; and an initial prediction period during which a handover event is expected to occur; (c) receiving, over an uplink control channel from the device, a proactive handover event prediction report, the report including: a handover event indication; a handover prediction period, including a start slot index and a number of upcoming slots for which the prediction is valid; and an identifier of a target RAN node toward which the device predicts the handover may occur; (d) calculating remaining delay budgets for buffered packets intended for the device based on the received handover prediction report; (e) prioritizing scheduling and transmission of latency-critical packets that fall within the reported handover prediction period, such that they are transmitted during the time period preceding the start of the reported handover prediction period; and (f) triggering handover request procedures toward the reported target RAN node over a backhaul or XN interface.

The binary indication of AI-powered prediction capability may be included in uplink control information (UCI) or the uplink radio resource control (RRC) connection request signaling, transmitted by the device.

The handover event AI prediction configurations transmitted to the device may be carried in radio resource control (RRC) connection setup signaling or downlink control information (DCI) messages.

The minimum AI model confidence threshold may be adjusted based on the real-time network load conditions or quality of service (QoS) requirements.

The RAN node may calculate and determine the remaining real-time delay budgets for buffered packets based on received handover reports, and determined latency targets defined by their associated QoS class identifiers (QCIs).

The RAN node may override current scheduling priorities and instantly or near instantly schedule and transmitting determined latency-critical packets, of WTRUs of received handover prediction reports, during the time period preceding the reported handover prediction period.

The prioritization of determined latency-critical packets includes, in an embodiment, modifying transmission scheduling priorities based on the calculated remaining packet delay budgets relative to the reported handover prediction period.

The RAN node triggers a preemption procedure to release or reallocate resources, associated with the WTRU of a received handover prediction report, during the predicted handover period.

The RAN node may periodically reconfigure the prediction parameters transmitted to devices based on real-time network conditions and resource availability.

The advent of 5G New Radio (NR) technology has revolutionized cellular networks, offering unprecedented data rates, ultra-reliable low-latency communication (URLLC), and massive machine-type communication (mMTC) capabilities. These advancements enable a wide array of applications, including autonomous vehicles, remote surgery, and augmented reality. However, delivering seamless connectivity across diverse scenarios, such as high-speed vehicular environments and densely populated urban areas, remains a critical challenge. One key requirement for maintaining a high-quality user experience is ensuring seamless handovers between cells, which allows devices to transition between radio access network (RAN) nodes without service disruption. The high density of 5G base stations and the dynamic nature of modern networks further complicate this process, making efficient handover management a cornerstone of 5G performance.

AI/ML-based solutions offer significant enhancements to cellular connectivity through their ability to process vast amounts of data and derive predictive insights from historical network behavior. Recognizing the substantial benefits that AI/ML integration brings to wireless communication, the 3rd Generation Partnership Project (3GPP) has begun incorporating key support for these advanced techniques over the radio interface. The evolving 3GPP standards now include provisions for the exchange of AI/ML insights between the network and the radio interface, enabling real-time analysis and dynamic adjustments to radio resource management. This strategic inclusion paves the way for cellular systems to leverage machine learning models in optimizing network parameters, enhancing radio interface configurations, and ultimately delivering more adaptive and efficient communication services.

The consensus reached within 3GPP has enabled AI/ML model deployment flexibility by decoupling the intricacies of AI model utilization from the RAN. In this innovative framework, the RAN is not required to possess explicit knowledge regarding the specific AI/ML models employed by user devices, thereby fostering a dynamic environment where devices can autonomously implement and update their intelligence without impacting the core radio infrastructure. Such mindset presents the challenge of ensuring that these models remain applicable and effective under a diverse range of radio conditions and control parameters. Because the RAN is abstracted from the detailed workings of the AI/ML solutions, there is an inherent need for sophisticated radio control solutions that can bridge this gap.

In one exemplary embodiment, a wireless device manages on-device artificial intelligence (AI) models by first receiving, decoding, and storing one or more AI models along with associated metadata. The metadata includes a unified model identifier adhering to a predefined format standardized across the radio access network (RAN) and device for consistency (e.g., [RAN_ID]-[Model_ID]-[Version]), as well as version and priority information. The device then receives multiple base radio metrics-such as signal-to-interference-plus-noise ratio (SINR), channel quality indicator (CQI), access delay, reference signal received power (RSRP), and scheduling latency—from a RAN node, along with activation restriction conditions. The AI Model Manager (AMM) evaluates each AI model's output against these metrics and categorizes a subset as “RADIO” models if their outputs directly match or correlate with one or more of the received radio base metrics (e.g., a model predicting SINR trends). Non-RADIO models are marked accordingly. For each RADIO model, the AMM derives activation triggers (e.g., SINR falling below a threshold) and exit conditions (e.g., battery level dropping below 20%) from the metadata. It then compiles a primary map that exclusively includes RADIO-type models, structured to prioritize the highest-priority models. This map lists their unified model identifiers, versions, states (active/inactive), activation triggers, and exit conditions. A secondary map retains lower-priority RADIO models as backups for dynamic failover.

In one exemplary embodiment, the AI models and their corresponding metadata are received as part of non-access stratum (NAS) downlink signaling. The metadata includes a model identifier, version, priority indication, and an AI model type drawn from an expanded predefined set of enumerated types and subtypes to ensure granular categorization. These subtypes include RADIO (e.g., models for channel state prediction subtype, interference mitigation subtype, or beamforming optimization subtype), VIDEO (e.g., adaptive bitrate streaming subtype or frame prediction subtype), VOICE (e.g., noise suppression subtype or codec optimization subtype), ENERGY_EFFICIENCY (e.g., power-saving scheduling subtype or battery lifetime prediction subtype), MOBILITY (e.g., handover optimization subtype or location-triggered resource allocation subtype), SECURITY (e.g., anomaly detection subtype or encryption key management subtype), QoS_OPTIMIZATION (e.g., latency-sensitive traffic prioritization subtype), and TRAFFIC_PREDICTION (e.g., data usage forecasting subtype). The AI Model Manager (AMM) performs an initial functional categorization of each model based on its designated type, such as labeling a model as MOBILITY if it predicts handover events. Concurrently, the device receives radio base metrics-including SINR, CQI, RSRP, access delay, and scheduling latency-via downlink RRC or DCI signaling. If an AI model's output directly matches or correlates with these metrics (e.g., a TRAFFIC_PREDICTION model indirectly influencing CQI through data burst forecasts), the AMM overrides the initial categorization, reclassifies the model as RADIO, and mandates uplink status reporting. This dynamic reclassification ensures alignment with real-time RAN conditions, even for models not originally designated as radio-critical.

In another embodiment, the device determines specific activation triggers and exit conditions for each AI model based on predetermined criteria provided in the metadata. For example, activation triggers might be configured to initiate inference of an AI model only when a particular SINR range is observed, whereas exit conditions might be tied to battery capacity thresholds that mandate deactivation of AI model inference. When multiple versions of an AI model—each associated with a unique priority level—are received, the system compiles two distinct maps: a primary map that includes the higher priority RADIO models and a secondary map for lower priority versions. Should a new downlink signaling update be received that contains revised version or priority information for a given model, the wireless transmit/receive unit (WTRU) processes the update to adjust the mapping and management of the AI model, potentially swapping a higher priority model into the primary map in lieu of an existing model with a lower priority.

Moreover, the WTRU continuously monitors and validates the availability of mandatory inputs and the fulfillment of the designated exit conditions for the active AI models in the primary map. In embodiments where the any of the required inputs are missing or one or more exit conditions are fulfilled for a particular high-priority model, the WTRU deactivates the model and checks for the presence of a corresponding lower priority model in the secondary map. Upon determining that the lower priority model meets the necessary input availability and triggering conditions under current radio conditions, the system swaps the lower priority model into the primary map to maintain consistent AI inference operations. The execution of AI model inference is thereby dynamically managed based on real-time input availability and environmental conditions.

In an additional embodiment, when the primary map contains active higher priority RADIO models, the WTRU determines and compiles a numerated list of all possible exit conditions associated with these models and transmits this compiled list as uplink control information to the RAN node. The system may also receive NAS signaling rules that indicate activation restriction conditions, such as geolocation coordinates, specific service IDs, or traffic flow bearer indications, which limit the activation of AI models. Upon checking and validating these activation restriction conditions, the device may preemptively stop and deactivate all active RADIO models in the primary map, thereby overriding individual AI model-specific triggering and exit conditions. Furthermore, the WTRU transmits AI model status reports in response to state transitions-either from a non-active to an active state or vice versa—that include the active or deactivated model IDs along with a request for radio capability adjustments, such as modifications to channel state information reference signal (CSI-RS) patterns, phase tracking reference signal (PTRS) patterns, or scheduling delay levels, that are needed due to the state transitions of the one or more AI models.

Non-RADIO models may or may not be handled according to device implementation and those may or may not require RAN enforcement or awareness and so. Thus, these models may or may not be out of both model maps since the purpose of those maps is to track state transitions and model performance for mandatory RAN reporting. The RAN may or may not be interested in knowing AI model state of a model that works on user screen activity for instance.

In an embodiment, within a coordinated multi-WTRU configuration, the wireless device is adapted for deployments requiring synchronized intelligence exchange across interconnected devices. This includes scenarios such as multi-device interactive extended reality (XR) (e.g., collaborative AR/VR environments), coordinated vehicular platooning (e.g., vehicle-to-vehicle communication for autonomous convoy management), and industrial IoT clusters (e.g., machinery synchronization in smart factories), where proximity-based devices jointly execute shared AI-driven tasks. When a RADIO AI model associated with a device-common application (e.g., platoon path prediction or XR session synchronization) is deactivated or transitions from active to non-active state, the WTRU compiles an AI model exit indication. This indication specifies the deactivated model's identifier and is transmitted over the side-link interface as part of the side-link control information (SCI) group signaling. By broadcasting this exit notification, peer WTRUs in the coordinated group-such as vehicles in a platoon or XR headset clusters—are alerted to the discontinuation of the AI model's execution. This enables network-wide synchronization, preventing inference conflicts (e.g., mismatched platoon acceleration commands) and ensuring seamless adaptation to dynamic group operational states.

One key challenge of cellular AI-enabled deployments is the arbitrary deployment of AI models, where devices independently download and execute models from various vendors for an array of functions, spanning both radio and non-radio applications. This decentralized approach to AI model acquisition and utilization lacks a standardized coordination mechanism with the radio access network (RAN), leading to a fragmented and ungoverned ecosystem.

A critical challenge emerges in the absence of RAN oversight to govern AI models that directly or indirectly influence radio performance. Without RAN-enforced control, AI models optimized for specific operational thresholds (e.g., trained under high-SINR conditions) may operate outside their validated design limits-such as in low-coverage zones or congested interference scenarios-leading to erratic behaviors. These behaviors could destabilize radio functions, including signal modulation, interference mitigation, or resource allocation, thereby degrading network performance. To mitigate this, RAN oversight ensures that AI models impacting radio operations are restricted to their predefined training domains (e.g., geofenced areas, SINR ranges, or traffic load levels). If an AI model exceeds these boundaries or exhibits misalignment (e.g., generating conflicting beamforming commands), the RAN node triggers a fallback protocol, overriding the AI-driven process and reverting the impacted radio functions to standardized, non-AI device actions. For example, the RAN may disable an AI-based scheduling model and restore legacy scheduling algorithms to maintain network stability. This safeguards against uncontrolled AI inference while preserving baseline radio integrity.

In addition, the dynamic nature of AI model activation and deactivation on devices further compounds the problem. Devices may autonomously switch models on or off, including those that directly influence radio parameters, without notifying or coordinating with the RAN node. This independent control can result in significant operational risks, such as inefficient resource allocation and degraded network efficiency, because the network lacks real-time insight into the AI-driven changes affecting its radio interface.

Collectively, these issues underscore the urgent need for an intelligent AI model management framework that harmonizes AI-driven operations while preserving network integrity. Such a framework would enable standardized governance, ensuring that AI models are deployed, activated, and deactivated in a manner that is fully coordinated with the RAN. By establishing robust control and communication protocols between device-level AI operations and the network infrastructure, it becomes possible to mitigate risks, enhance stability, and maintain optimal performance across the wireless ecosystem.

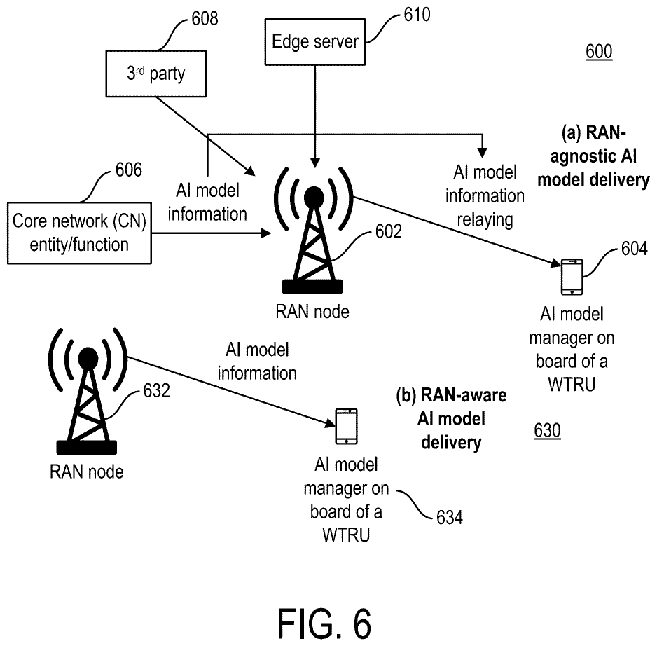

FIG. 6 illustrates different options 600, 630 for the delivery of AI model information to wireless devices 604, 634, highlighting the varying levels of RAN node involvement and awareness. In one configuration 600, AI model information originates from an external third-party vendor 608, an edge server 610, or a core network function 606. In this scenario, the RAN node 602 acts purely (or near-purely) as a relay, forwarding the AI model information as data over the radio interface to wireless device 604 without any direct involvement in its selection, validation, or execution. Because the AI model delivery occurs independently of the RAN's operational intelligence, the network remains unaware of the specific AI models deployed on devices, their functions, or their training boundaries. This approach enables flexible and rapid AI model provisioning but introduces challenges in ensuring network-wide coordination, as AI models influencing radio behavior may operate without RAN oversight.

In another configuration 630, the AI model information is RAN-native, meaning that the AI models are generated, processed, and managed within the RAN node itself. In this case, the RAN node possesses full awareness of the AI models being utilized, including their intended functions, training parameters, and operational constraints. This configuration allows the RAN to enforce stricter governance over AI model execution, ensuring that models interacting with radio functions operate within predefined performance and reliability thresholds. By centralizing AI model intelligence within the RAN, the network may optimize model deployment, dynamically adjust AI-driven processes, and maintain greater control over AI-influenced radio functions. However, this approach may introduce computational overhead for the RAN node, as it handles AI model training, validation, and execution alongside its core radio processing responsibilities. Configuration 630 includes a RAN node 632 providing AI model information to a wireless device 634.

Another example configuration, though less favored due to the processing burden it places on the RAN, is beneficial for scenarios where AI model inference is conducted collaboratively by both the RAN and the device. In this dual-sided inference model, the RAN node not only generates or processes the AI model but also actively participates in executing inferences alongside the wireless device. This ensures a higher degree of synchronization between AI-driven device operations and network-level decision-making, improving overall efficiency in cases where real-time AI-driven optimizations are necessary. While computationally intensive, this approach is particularly valuable in applications that require joint AI processing, such as coordinated interference management, adaptive beamforming, or predictive resource scheduling.

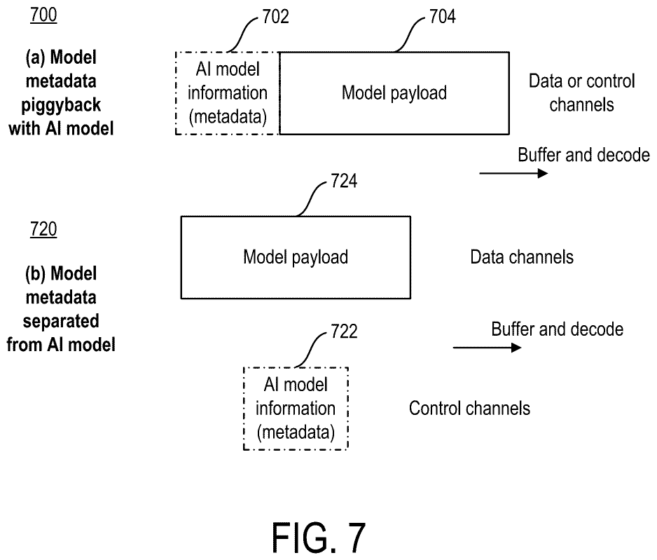

FIG. 7 illustrates different methods 700, 720 for delivering AI model metadata to a wireless device, highlighting the trade-offs between reliability and efficiency. In one configuration, AI model metadata 702—along with additional one or more information elements such as security credentials (e.g., digital signatures or encryption keys for model authentication), usage policies (e.g., geofencing coordinates, time-of-day restrictions, or permitted service types), input requirements (e.g., mandatory sensor data types or radio metric thresholds for execution), fallback procedures (e.g., predefined non-AI algorithms to trigger on model failure—is transmitted by piggybacking it with the AI model data itself. In this approach, the metadata is appended as part of the model payload 704, ensuring that each AI model carries its corresponding metadata within the same transmission. Upon reception, the device buffers the entire AI model payload until it has received the metadata in full. Once the metadata is fully decoded, the device proceeds with installing and activating the AI model. This method is favored because it maintains a direct association between each AI model and its respective metadata, reducing the risk of mismatches or synchronization issues between separately transmitted model files and metadata descriptors. However, a key drawback is that metadata, which functions as critical control information, is now being transmitted over data channels. Since data channels are optimized for bulk data transmission rather than control signaling, the reliability of metadata decoding may degrade, especially under poor channel conditions.

In another configuration 720, AI model metadata 722 is transmitted separately over control channels, while the actual AI model delivery occurs through data channels. This ensures that metadata 722, which carries essential information such as model identifiers, versioning, priority levels, and activation constraints, is received with the highest possible reliability. Control channels are specifically designed for signaling and are inherently more robust against transmission errors compared to data channels. By leveraging the control plane for metadata delivery, this approach minimizes the risk of corrupted or lost metadata 722, ensuring that devices receive and interpret model parameters accurately before installation and activation. Meanwhile, the AI model itself is transmitted over data channels, which are optimized for large payload transfers. This separation of metadata and model delivery increases overall transmission efficiency and reliability but introduces the added complexity of synchronizing metadata with its corresponding AI model payload 724 at the device side.

Based on the second configuration setting, the metadata for an AI model is received via downlink control information (DCI) signaling over a control channel, where the DCI explicitly indicates resource allocations reserved for transmitting the corresponding AI model over downlink data channels. The wireless device decodes the DCI to extract metadata elements-such as model identifier (ID), version, priority, and activation constraints-alongside time-frequency resource assignments (e.g., physical resource blocks, modulation schemes) allocated for the AI model payload. Using the decoded resource allocations, the device receives and assembles the AI model data transmitted over the scheduled downlink resources. The metadata is then applied to configure, validate, and activate the AI model. To support multiple models, the DCI may include multiple resource allocation entries, each mapped to a distinct model ID. For instance, a single DCI message could allocate separate resource blocks for a RADIO-type beamforming model (ID: RAN-001) and an ENERGY_EFFICIENCY-type power management model (ID: RAN-002), with metadata bits specifying model-specific parameters such as priority flags or input requirements.

Further, existing DCI formats (e.g., DCI 1_0 or DCI 1_1), traditionally used for downlink scheduling, are extended to include AI-specific metadata fields. Reserved bits in the DCI payload are repurposed to encode model identifiers (e.g., 8-bit alphanumeric tags) and metadata parameters (e.g., 4-bit priority levels or version compatibility flags). This backward-compatible approach allows legacy devices to ignore AI-specific fields while enabling AI-capable devices to decode both scheduling grants and AI governance rules from the same DCI. Alternatively, a new DCI format (e.g., DCI Y_X) is defined exclusively for AI model control, isolating AI metadata and resource allocations from conventional scheduling commands. This dedicated format includes fields such as a model ID list (e.g., hashed identifiers for RADIO, VIDEO, or other AI models), resource block groups allocated per model ID, metadata containers (e.g., input requirement thresholds or geofencing coordinates), and activation triggers (e.g., SINR thresholds for RADIO model execution). AI-capable devices monitor this DCI format using a predefined radio network temporary identifier (RNTI), ensuring only authorized devices process AI control signaling. For example, a vehicular WTRU in a platoon decodes DCI Y_X to retrieve a RADIO model ID (e.g., V2V_PLATOON_OPT) and its resource grants, enabling prioritized download of collision-avoidance AI models during high-speed operation.

TABLE 5
AI model information (metadata)
AI model information (metadata)

| | |
|---|---|
| AI model ID x | Version x_n |
| | Priority level p_x_n |
| | Trigger conditions t_x_n_1, t_x_n_2, . . . |
| | Exit conditions e_x_n_1, e_x_n_2, . . . |
| | Category/type: non-RADIO or ‘001’ |

Table 5 illustrates the message structure of the AI model information to a wireless device, specifically highlighting the content of AI model metadata received as part of non-access stratum (NAS) downlink signaling. The AI model message is comprised of two primary components: the AI model payload, which contains the executable model itself, and the associated metadata, which provides crucial information for AI model management and execution. The metadata is embedded within the NAS signaling to ensure structured and standardized communication between the network and the device, allowing for efficient categorization, prioritization, and activation of AI models based on their designated functionalities.

The AI model metadata includes several key fields that define the characteristics of the received model. One of the core components is the Model ID, a unique identifier assigned to each AI model instance. This ensures that devices can accurately track, update, and manage different AI models without conflicts. Additionally, the metadata contains a Model Version, which enables version control, allowing the device to determine whether the received model is an update to an existing version or a completely new AI model. This versioning mechanism helps prevent outdated models from being executed and ensures that the device always utilizes the most optimized and compatible AI models.

To ensure global uniqueness of AI Model IDs across the entire RAN network, the system employs a centralized model registry managed by a core network entity, such as an Operations, Administration, and Maintenance (OAM) server. Each AI model ID is generated as a composite identifier comprising a public land mobile network (PLMN) identifier unique to the operator's network, a timestamp reflecting the model's creation or deployment time (e.g., epoch milliseconds), a cryptographic hash derived from the model's architecture and training parameters (e.g., SHA-256 of model weights), and a sequentially incremented counter to resolve collisions within the same PLMN and timestamp. For example, a RADIO model for beamforming optimization in a 5G network operated by PLMN “001-01” might receive an ID formatted as 00101-1625000000-7a3b9c . . . ef-0001, where “00101” is the PLMN, “1625000000” is the epoch timestamp, “7a3b9c . . . ef” is the hash, and “0001” is the collision counter. This structured approach guarantees uniqueness across operators, as the PLMN ID inherently segregates network-specific deployments.

In an alternative embodiment, uniqueness is enforced through decentralized coordination, where RAN nodes autonomously generate model IDs using a hierarchical namespace. Each RAN node is assigned a unique node identifier (e.g., gNB-ID or cell-ID) as the root prefix, followed by a model category code (e.g., RADIO, VIDEO) from a standardized enumeration, a vendor-specific identifier (e.g., manufacturer code), and a locally managed unique suffix (e.g., UUID). For instance, a RAN node with ID “gNB-1234” deploying a vendor “XYZ” RADIO model would generate a model ID as gNB-1234-RADIO-XYZ-550e8400-e29b-41d4-a716-446655440000. This hierarchy prevents overlaps across nodes, vendors, and categories, while the UUID ensures local uniqueness. RAN nodes periodically synchronize deployed model IDs with the core network, which audits for duplicates and triggers re-issuance of conflicting IDs.

Another essential field in the metadata is the Priority Indication, which dictates the relative importance of the AI model. AI models with a higher priority may be allocated processing resources ahead of lower-priority models, ensuring that critical functions such as radio-based optimizations are executed in a timely manner. The AI Model Type Indication is another key component, which classifies the AI model according to a predefined set of enumerated types. These types include (000, ‘VIDEO’), (001, ‘RADIO’), (010, ‘NON-RADIO’), (110, ‘VOICE’), and (001, ‘ENERGY EFFICIENCY’). This classification allows the AI Model Manager within the device to determine the primary function of the received model and manage it accordingly. For instance, models categorized under ‘RADIO’ may directly influence wireless communication parameters, while those under ‘VIDEO’ may optimize multimedia processing.

An AI model management tool may or may not be useful in low complexity devices, depending upon capability and how low complexity the devices are. With the very low capability requirements of those devices, eg., single antenna, low bandwidth, single stream, maximum number of allowable control channel decoding's, etc, it may be hard to employ some of the AI models disclosed herein, however these devices may support others.

The AI model metadata structure can be expanded to include hierarchical categorization through model types and subtypes, enabling precise functional classification. This requires augmenting the metadata's bit allocation to first encode a primary model type (e.g., RADIO, VIDEO, XR) followed by a subtype specifying specialized functionalities within that category. For example, a 3-bit field defines the primary type (e.g., 001 for RADIO), while a subsequent 4-bit subtype field distinguishes between RADIO subtypes such as beamforming optimization (0001), interference mitigation (0010), or handover prediction (0011). Similarly, an XR model type (e.g., encoded as 110) may include subtypes for virtual reality (VR: 0001), augmented reality (AR: 0010), or mixed reality (MR: 0011). This dual-layer encoding ensures backward compatibility-legacy devices interpret only the primary type, while advanced devices decode both layers to tailor execution policies.

To support dynamic subtype definitions, the RAN node broadcasts subtype mapping tables via system information blocks (SIBs) or RRC reconfiguration messages. These tables define interpretations for subtypes under each primary type, enabling network operators to introduce new functionalities without firmware updates. For example, a RADIO subtype for AI-driven massive MIMO precoding (e.g., 001-0101) is added by updating the RAN's mapping table, which devices decode during idle-mode procedures. This ensures scalability across evolving AI use cases while maintaining metadata efficiency. Subtypes further enable context-aware execution—e.g., an XR model with an AR subtype (110-0010) prioritizes low-latency uplink resources for sensor data, whereas a VR subtype (110-0001) allocates high-throughput downlink resources for immersive streaming.

Once the AI Model Manager receives the AI model metadata, it evaluates the AI Model Type Indication to establish a functional categorization of the model. Based on this categorization, the AI Model Manager selectively processes the model according to its designated function. For example, if an AI model is identified as a ‘RADIO’ model, it may be assigned specific processing constraints and prioritized for execution in scenarios where radio conditions are dynamically changing. Conversely, if a model falls under ‘NON-RADIO’ or ‘ENERGY EFFICIENCY,’ it may be managed differently, ensuring that system resources are appropriately allocated to maximize efficiency without interfering with critical radio functionalities.

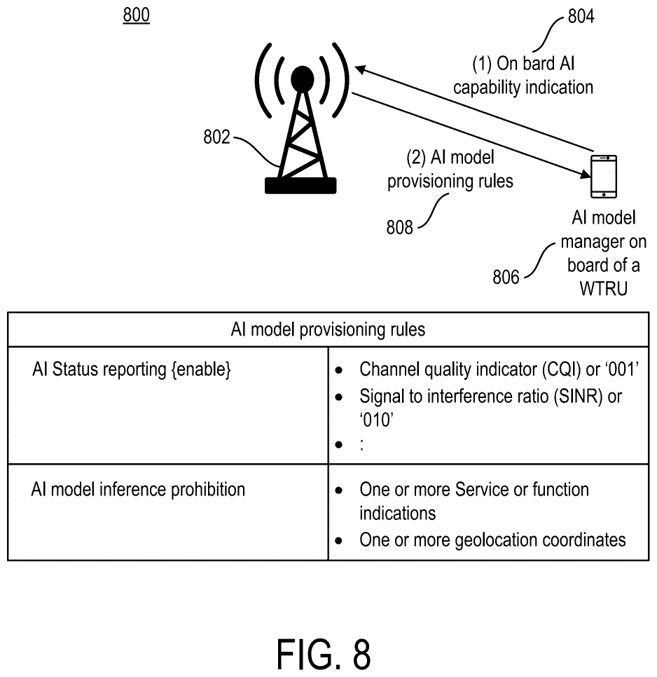

FIG. 8 illustrates a process 800 by which a Radio Access Network (RAN) node provisions AI model operational rules 808 to devices, including WTRU 806, ensuring that all AI models categorized as RADIO models adhere to RAN-defined provisioning conditions. These provisioning rules are communicated via downlink Radio Resource Control (RRC) signaling or Downlink Control Information (DCI) and serve as a governance mechanism for AI models that directly influence radio functions. The RAN node mandates that AI models classified as RADIO models may operate under both their specific model-defined triggers and exit conditions as well as the overarching radio-based provisioning rules enforced by the network. This ensures consistency in AI-driven radio optimizations while preventing uncoordinated AI model behavior that could negatively impact network performance. Specifically, RAN node 802 receives capability information 804 from a WTRU 806 and provides AI model provisioning rules 808 to the WTRU 806.

The RAN node provisions AI model governance configurations via downlink signaling, mandating uplink status reporting from AI-capable devices executing RADIO-categorized models. These configurations are transmitted through RRC signaling for semi-static parameters, such as reporting intervals (e.g., every 10 seconds for active RADIO models) and event-triggered criteria (e.g., reporting when SINR degrades below 5 dB or a model exits due to low battery). Concurrently, DCI signaling dynamically adjusts reporting rules in real time—for instance, forcing immediate status updates during network congestion. Devices compile reports containing model states (active/inactive), operational metrics (e.g., inference latency), and exit condition fulfillment status, transmitting them via configured uplink channels. The RRCReconfiguration message may include an AI-StatusReportConfig Information Element (IE) specifying metadata requirements (e.g., model ID, version, inference accuracy) and uplink resource allocations (e.g., PUCCH/PUSCH grants) to ensure structured reporting.

Further, to enforce compliance, the RAN may embed activation flags within DCI or RRC signaling that mandate status reporting exclusively for RADIO models impacting radio performance. For example, a DCI command with a 1-bit AI-StatusRequest flag triggers a device to transmit a status report in the next uplink slot if it hosts active RADIO models. The report adheres to a predefined AI-StatusReport MAC Control Element (CE), encapsulating fields such as the model ID, version, current state (active/inactive/error), correlated radio metrics (e.g., CQI, RSRP at inference time), fulfilled exit conditions (e.g., “battery <20%”), and resource requests (e.g., additional PRBs for high-priority models). The RAN leverages these reports to audit model behavior, adjusting provisioning rules (e.g., revoking permissions for misbehaving models) or reallocating resources (e.g., increasing CSI-RS density for AI-driven beamforming models).

One critical aspect of this provisioning process is the delivery of radio base metrics, which the RAN node transmits to devices via RRC or DCI signaling. These base metrics include, but are not limited to, Channel Quality Indicator (CQI), Signal to Interference Noise Ratio (SINR), Signal to Noise Ratio (SNR), and Reference Signal Received Power (RSRP). Upon receiving these metrics, the AI Model Manager (AMM) within the device cross-references them with the output of any active AI model. If an AI model's output directly matches or correlates with one or more of these base metrics-such as an AI model predicting downlink signal strength, which contributes to the calculation of SINR—the AMM designates the AI model as a RADIO model. This classification mandates the activation of uplink control signaling-based status reporting, ensuring that the RAN node is continuously informed of AI model behaviors influencing radio parameters.

The AI Model Manager (AMM) operates as a centralized arbiter, dynamically aligning AI application performance with radio resource requirements. The AMM monitors AI inference metrics-such as computational latency, prediction accuracy, and resource consumption- and translates these into radio-specific constraints or requests. For example, a RADIO model optimizing beamforming may require real-time channel state information (CSI) updates with sub-millisecond granularity. The AMM converts this need into a scheduling request for increased CSI-RS (Channel State Information Reference Signal) density or dedicated PUCCH (Physical Uplink Control Channel) resources to meet latency targets. Similarly, an ENERGY_EFFICIENCY model predicting battery drain might mandate reduced uplink reporting intervals, which the AMM translates into a radio capability relaxation request (e.g., extended DRX cycles) transmitted to the RAN via RRC signaling.

Furthermore, the AMM enforces performance-radio dependency rules, where AI models are bound to predefined service-level agreements (SLAs). For example, an XR model requiring 90 fps rendering may correlate with guaranteed bitrate (GBR) bearer configurations and low-latency HARQ processes. If the RAN cannot meet these SLAs (e.g., due to PRB scarcity), the AMM either deactivates the AI model or triggers fallback procedures (e.g., switching to a lower-resolution XR subtype).

For multi-model coordination, the AMM further prioritizes RADIO models influencing mission-critical functions (e.g., interference cancellation) over non-RADIO models (e.g., background video enhancement). This may require the AMM to actually override the determined AI model priority from its metadata. This hierarchy is enforced through priority-based resource locking, where high-priority models reserve exclusive access to resources like non-radio capabilities such as GPU cycles or radio capabilities such as CSI-RS configurations. The AMM further mediates conflicts-such as overlapping bandwidth requests from a RADIO beamforming model and a VIDEO streaming model—by applying weighted fairness algorithms that bias allocations toward radio-stability objectives.

The provisioning framework also allows for dynamic AI model reclassification based on real-time analysis of AI model outputs. When an AI model is initially received, its metadata contains an AI model type indication, which suggests an intended classification, such as VIDEO, RADIO, or ENERGY EFFICIENCY. However, upon deployment, the AMM further evaluates the AI model's output against the received radio base metrics. If the AI model's output is determined to correlate with or directly impact one or more of these base metrics, the AMM overrides the initial classification and updates the model type to RADIO. This ensures that any AI model affecting network radio parameters is brought under strict RAN governance, even if it was originally categorized differently.

Additionally, the RAN node provisions model triggering conditions and exit conditions, which define when an AI model should be activated or deactivated. The triggering conditions specify preconfigured thresholds, such as an SINR range that may be met for the AI model to begin inference operations. Similarly, exit conditions define criteria under which an AI model should be deactivated, such as a battery capacity level threshold, preventing unnecessary energy consumption in low-power scenarios. These conditions, communicated by the RAN node, are layered on top of the model-specific activation and deactivation rules defined within the AI model itself, ensuring a harmonized and network-aware execution framework.

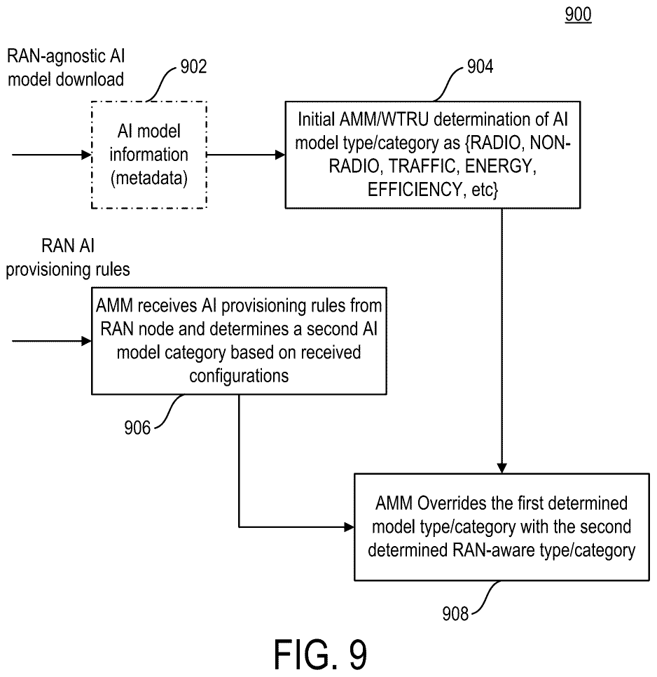

FIG. 9 illustrates a process by which the AI Model Manager (AMM) dynamically reclassifies an AI model's type when its functional impact extends beyond its initially determined category. This override mechanism is triggered when the AI model's real-world behavior influences network parameters that are classified as radio base metrics, ensuring that AI-driven decisions remain aligned with RAN-defined operational priorities.

Initially, an AI model may be categorized based on its metadata, which includes information such as model ID, version, and type indication. For instance, a specific AI model designed for energy efficiency may be classified under this category because its primary function is to optimize power consumption. Such a model might predict paging patterns, allowing a device to extend its sleep cycles by skipping paging occasions that it deems unlikely to contain a true page. This results in significant power savings for the device, which aligns with the initial energy efficiency classification.

However, the extended sleep duration introduced by this AI model has direct implications on paging detection reliability and network access delay, both of which are critical radio key performance indicators (KPIs). If the RAN has provisioned these metrics as base parameters, the AMM at the device evaluates the AI model's output against them. If it detects that the model's decisions affect paging-related KPIs-such as by increasing the probability of missed pages or introducing excessive access delays—the AMM overrides the first-determined category of “ENERGY EFFICIENCY” and reclassifies the AI model as a “RADIO” model instead.

With this reclassification, the AI model is now governed by additional RAN-imposed constraints, ensuring that its operation does not degrade network performance. For example, the device may be required to report status updates on the model's impact via uplink control signaling, or the RAN may mandate stricter activation and exit conditions to prevent excessive paging failures. This override mechanism ensures that any AI model influencing radio-layer operations is brought under strict network oversight, regardless of its original metadata classification.

By dynamically reassessing AI model categorizations based on real-time network impact, the AMM plays a crucial role in maintaining network stability and efficiency. Without such an override mechanism, an AI model originally designed for, for instance, energy savings could unintentionally disrupt critical radio functionalities, leading to degraded user experience and increased signaling overhead. This framework thus ensures that AI-driven optimizations do not compromise essential network KPIs and reinforces a structured governance model for AI model deployment within wireless communication systems.

Specifically, FIG. 9 shows that AI model information including metadata may be processed by the AMM. The AMM may make an initial determination to categorize the AI model as one of {radio, non-radio, traffic, energy efficiency, or another}. The AMM may also receive AI provisioning rules 906 and based on these rules, may override 908 the initial determination.

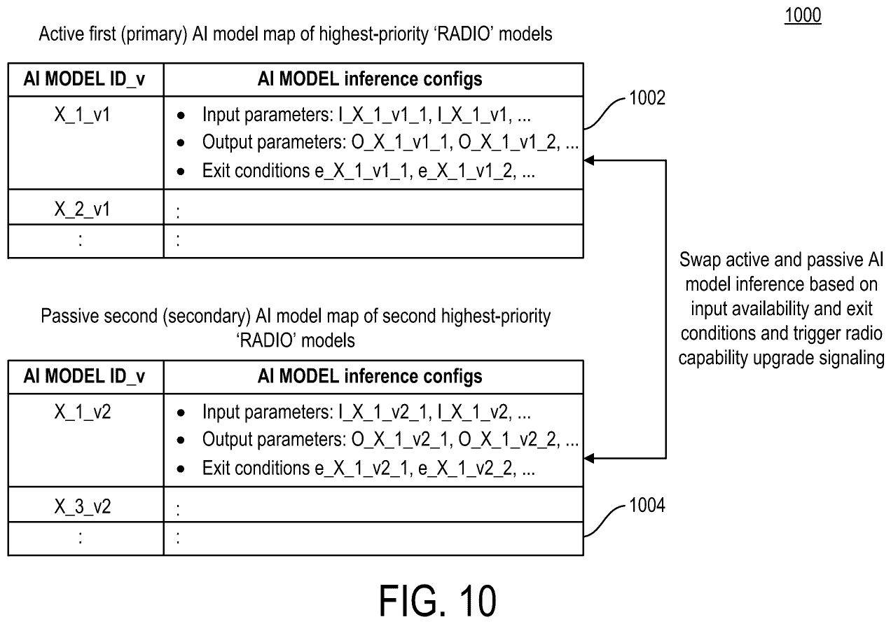

FIG. 10 is an illustration 1000 of the mapping, prioritization, and dynamic management of AI models, particularly those classified as RADIO models, within a wireless communication system. The AI Model Manager (AMM) is responsible for maintaining structured AI model maps that categorize, rank, and update AI models based on their relevance and priority, ensuring optimal model execution under changing network conditions.

The AMM constructs a first map 1002 that compiles all AI models explicitly categorized as RADIO models. This map includes essential metadata such as the AI model ID, model version, model state (active or inactive), model triggering conditions, and model exit conditions. The purpose of this map is to provide a real-time reference for AI models actively influencing radio parameters, ensuring the RAN node or the AMM can enforce appropriate model execution policies.

When multiple versions of the same AI models exist, each associated with a different priority level, a second map 1004 is introduced to manage lower-priority versions. The first map retains only the highest-priority version of each model, ensuring that only the most relevant and optimized models are actively executed. The second map stores lower-priority versions for potential fallback scenarios where the higher-priority model may no longer be applicable. The AMM dynamically updates these maps whenever it receives downlink signaling updates containing new model metadata, revised version information, and adjusted priority levels.

Upon receiving an AI model update with an already stored model ID, the AMM assesses the updated version's priority level. If the update introduces a higher-priority version, the AMM swaps the new model into the first map, ensuring that the most critical and optimized AI model is always prioritized for execution. Simultaneously, the lower-priority model is transferred to the second map, where it remains as a passive backup until needed. This real-time priority management allows the system to maintain network efficiency, resource allocation accuracy, and optimal AI-driven decision-making.

An alternative mapping approach involves ranking all received AI model versions for the same model ID and storing them across multiple AI model maps, organized in descending priority order. This ensures that all versions remain available for fallback if required while maintaining strict execution control over the most critical model.

On condition of an AI model in the first map reaches its exit condition-such as depleting necessary input parameters or becoming irrelevant due to network changes—the AMM automatically deactivates the model and checks whether a lower-priority version of the same model exists in the second map. If such a model is found, and its input availability and triggering conditions are met, the AMM swaps the lower-priority model into the first map to replace the deactivated version. This ensures continuous AI model availability while maintaining execution integrity.

When the AMM fails to locate a lower-priority version of the active AI model in the secondary map, it proceeds to deactivate the higher-priority model in the primary map, thereby terminating its associated AI run functionality. This deactivation is executed to prevent the system from operating with a model that no longer satisfies the required execution parameters or network conditions. The system's decision-making logic evaluates the unavailability of a swap candidate as a trigger to cease operation of the higher-priority model, thus ensuring that resource allocation remains consistent with current operational requirements and avoids potential conflicts or inefficiencies in model deployment.

Following the model deactivation, the AMM may initiate a radio uplink transmission conveying the current state of the AI model to a designated RAN node, e.g., AI model state signaling. This transmission is designed to relay critical state information that reflects the model's operational context at the time of shutdown. Concurrently, the AMM may issue a radio capability upgrade request, which serves to enhance the network's processing capabilities in order to compensate for the diminished AI intelligence resulting from the model deactivation. The upgrade request typically involves provisioning additional computational resources or enabling enhanced radio features to maintain optimal system performance.

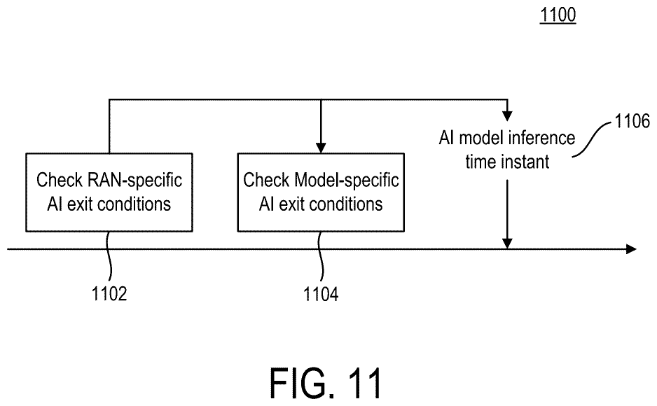

FIG. 11 illustrates the WTRU behavior 1100 of the dynamic activation and deactivation of RADIO models in response to AI model activation restriction conditions. The AI Model Manager (AMM) first checks and validates whether any of the AI model activation restriction conditions are satisfied before proceeding with AI model inference or activation. These conditions could include factors like network resource availability, device-specific limitations, or external network events that may affect the feasibility or efficiency of executing certain AI models.

If the AMM determines that one or more activation restriction conditions are met, it preemptively stops and deactivates all active RADIO models stored within the first AI model map. This action ensures that AI models affecting critical radio parameters are temporarily suspended to avoid potential interference with the system's operational stability. During this process, the AMM overrides any AI model-specific triggering and exit conditions, essentially pausing any ongoing execution of the AI models, regardless of whether their individual conditions for activation or deactivation are fulfilled. This precautionary measure ensures that no unnecessary processing takes place when network conditions or other factors make it unwise to continue running RADIO models.

Once the activation restrictions are lifted or conditions improve, the system can revalidate the activation conditions for the RADIO models, potentially allowing them to resume operations. This dynamic control mechanism provides the system with the flexibility to manage AI models efficiently while maintaining system integrity during periods of restricted operation.

In parallel, the AMM continues executing AI model inference for higher-priority models stored in the first compiled AI model map. This inference execution is dependent on the availability of required inputs and the fulfillment of the corresponding triggering conditions. The AMM may only activate and execute inference for models if all necessary conditions, such as network parameters or device state, are met. This process ensures that higher-priority AI models, which are essential for maintaining network performance, are given precedence, and their operation is optimized based on real-time network conditions.

Specifically, a WTRU may check RAN-specific AI exit conditions 1102 before checking model specific AI exist conditions 1104. The WTRU performs AI model inference 1106 when no exit conditions are met.

A signaling procedure may be triggered by the WTRU (Wireless Transmit/Receive Unit) to communicate AI model state changes and potential radio capability upgrade requests to the RAN (Radio Access Network). This signaling is sent in the uplink direction and serves as a means for the WTRU to inform the RAN node when there is a transition in the state of a RADIO AI model, which can include transitions such as activation, deactivation, or reconfiguration. When such a state transition occurs, the WTRU may trigger specific signaling to indicate to the RAN node that the AI model's status has changed and that additional adjustments may be required on the radio side to maintain optimal performance. Specifically, an AI model manager on board of a WTRU may send an AI model status and radio capability upgrade message to a RAN node.

For example, when a RADIO AI model is deactivated, its role in optimizing certain network parameters (such as interference management, resource allocation, or signal quality prediction) may be diminished. In such cases, the WTRU can send a request signaling to the RAN node, indicating that a radio capability upgrade or relaxation is needed. This may involve requests for the RAN node to enhance its radio resource management, such as increasing the number of reference signal transmissions or adjusting signal patterns to compensate for the loss of the AI model's assistance in maintaining optimal radio conditions.

The request signaling is crucial because it ensures that the WTRU does not experience degradation in performance, such as increased interference or reduced connectivity, after the deactivation of an AI model. The RAN node is thus made aware of the need for adjustments in its radio reference signal patterns, which are critical for maintaining coverage, capacity, and overall network performance. The uplink signaling from the WTRU ensures that this request for radio capability upgrade or relaxation is communicated promptly and allows the RAN node to respond accordingly by enhancing or relaxing its radio transmission characteristics to better suit the current network conditions and WTRU needs.

Specifically, the WTRU transmits an update of the AI model state along with a radio capability upgrade or relaxation request as part of the uplink control channels. The transmission is designed to ensure that the RAN node reliably receives both the AI model state update and the corresponding radio capability request, thereby facilitating timely adjustments in the radio reference signal patterns to maintain optimal coverage, capacity, and overall network performance. The integration of the AI model state update with the radio capability request into the uplink control channels leverages the inherent reliability and low latency of these channels, which are conventionally employed for critical signaling purposes.

On condition the RAN node does not successfully receive the initial transmission of the uplink control information, the AMM/WTRU is configured to repeat the transmission with a higher repetition order, as defined for conventional uplink control signaling. This repeated transmission procedure is activated automatically under conditions where acknowledgment or confirmation of receipt is absent, thereby increasing the robustness of the communication link between the WTRU and the RAN node. The use of an elevated repetition order in the repeated transmissions ensures that, even in the presence of challenging radio conditions or potential interference, the critical information regarding the AI model state update and the radio capability request is eventually conveyed reliably.

TABLE 6
AI model status and radio capability upgrade
AI model status and radio capability upgrade

| | |
|---|---|
| AI Model information | AI model ID X_1_v1 |
| | Triggered exit condition indication {‘00010’} |
| | Triggered trigger condition indication {‘0110’} |
| Radio capability | CSI-RS (start, increase) |
| upgrade/relaxation | PTRS (start, increase) |
| | Scheduling delay (reduce to a maximum of x ms) |

Table 6 illustrates the message content of the AI model status report to the RAN node in the event of a transition from non-active to active status for a RADIO AI model. When such a transition occurs within the first AI model map, the WTRU sends a detailed status report to the RAN node, which includes the ID of the active AI model and various requests for radio capability relaxation. These adjustments may involve the reduction or cessation of certain reference signals that are used for network performance optimization. Specifically, the WTRU may request the RAN node to stop or reduce the transmission of channel state information reference signals (CSI-RS), which are used to gather network quality data, and to adjust these signals according to a certain CSI-RS pattern indication. Similarly, the WTRU may request reductions in the transmission of phase tracking reference signals (PTRS), which are vital for tracking signal phases and improving synchronization between devices and the network.

Moreover, when a transition to an active RADIO AI model occurs, the WTRU may also request an increase in the maximum allowable scheduling delay, indicating that the network should allow more time for scheduling decisions, which can be necessary when the AI model's inferences are providing a different network behavior. This report helps ensure that the network can adapt to the new radio resource needs resulting from the AI model's active status, ultimately improving system efficiency by avoiding unnecessary or excessive resource allocation.

Conversely, when a non-active to active transition or a deactivation of a RADIO AI model occurs, a corresponding AI model update is sent to the RAN node. This update includes the ID of the deactivated model, the fulfilled exit conditions that led to the deactivation, and a request for radio capability upgrade. The WTRU may request enhancements to the network's radio resources, including increasing CSI-RS transmission to help maintain or improve network quality, or increasing PTRS transmission for enhanced phase tracking. Additionally, the WTRU may request that the maximum allowable scheduling delay be reduced to optimize network responsiveness, ensuring that the network compensates for the loss of the AI model and provides the necessary resources for optimal operation.

These signaling procedures provide a mechanism for the WTRU to inform the RAN node of the changes in the status of RADIO AI models and to request the necessary adjustments to the radio capabilities to accommodate these changes. The adaptive network behavior enabled by this signaling allows the network to maintain efficient performance by dynamically adjusting its radio resource management based on the current state of AI models. These processes contribute to a more resilient and responsive network that can handle transitions between active and non-active AI models while optimizing radio resources.

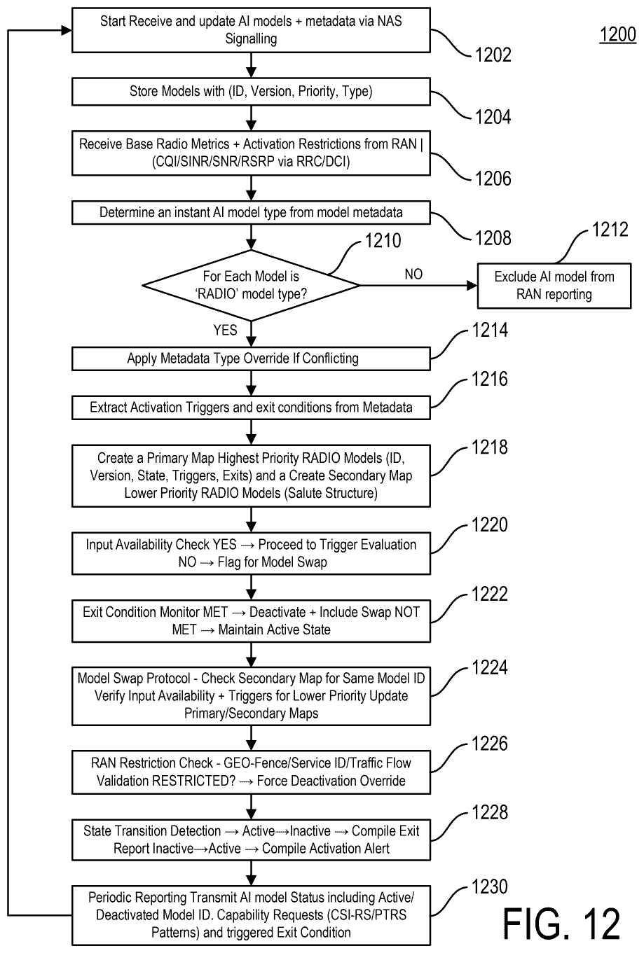

FIG. 12 illustrates the sequential flow of actions 1200 performed by the device to execute the adaptive AI model handling and reporting. Initially, the device receives AI model information from a third-party vendor, an edge server, or the core network function via the radio interface. This model information includes both the AI model data and its associated metadata. The device begins by buffering the model payload until it receives the full set of metadata, which is essential for the accurate installation of the model. Once the metadata is decoded, the device installs the AI model, at which point the device can evaluate the model's triggering conditions and exit conditions based on the received information.

Referring specifically to FIG. 12, the device may start 1202 by receiving and updating AI models and metadata via NAS signaling. The device may store models 1204 with ID, version, priority and/or type and the device may receive 1206 base radio metrics and activation restrictions from the RAN including CQI/SINR/SNR/RSRP via RRC or DCI. An initial AI model type may be determined 1208 from model metadata. For each model, the device may determine 1210 whether the model a RADIO model type. If not, the AI model may or may not be excluded 1212 from one or more RAN reporting methods. If the model is a RADIO model, the device may apply 1214 a metadata type override if conflicting. Activation triggers may be extracted 1216 and exit conditions from metadata.

The device may create 1218 a primary and secondary map. A primary map may denote the highest priority radio models (id version state triggers exits) and a secondary map may denote lower priority RADIO models (same or similar structure). The device may perform an input availability check 1220. If yes->proceed to trigger; evaluation no->flag for model swap.

Exit condition monitor 1222. If an exist condition is MET, deactive and initiate swap. If not met, maintain active state. Model swap protocol 1224: the secondary map may be checked for a same model id: verify input availability and triggers for lower priority. Primary/secondary maps may be updated.

A RAN restriction check 1226 may be performed If a GEO fence Service ID traffic flow validation determination is Restricted, force deactivation override. State transition detection 1228—active->inactive->compile exit report; inactive->active->compile activation alert. The device performs periodic reporting 1230. Transmit AI model status including active/deactivated model ID, capability requests (CSI-RS/PTRS patterns) and triggered exit condition. A return to start 1202 may be performed.

The device determines the AI model's category based on the metadata, which includes a predefined set of model types such as RADIO, VIDEO, NON-RADIO. If the model is categorized as a RADIO model, the device activates the model in accordance with its specified triggering conditions, such as the availability of relevant network metrics like signal-to-interference-plus-noise ratio (SINR) or channel quality indicator (CQI). Once activated, the device dynamically monitors the network performance and conditions, adjusting the model's behavior as necessary based on its predictive capabilities and the state of radio resources.

In situations where the model is categorized incorrectly or requires recalibration due to changes in network conditions, the device relies on the AI Model Manager (AMM) to process updates to the model. The AMM evaluates the model's output, comparing it to the real-time base metrics such as CQI and SINR, to determine whether the AI model should be reclassified. If the AMM finds that the current model classification does not align with the radio network's needs, it overrides the model's initial categorization and updates its classification to RADIO. This ensures that the device and the network maintain harmony in terms of radio resource management and AI model execution.

Specifically, the RAN node enforces the evaluation of active AI models by transmitting a downlink AI provisioning request to the device. This request instructs the AI Model Manager (AMM) to rigorously assess each active AI model's classification by comparing its output with predetermined radio base metrics, such as CQI and SINR. The downlink AI provisioning request includes specific parameters and threshold criteria that indicate the conditions under which an AI model's output is deemed to be correlated with radio performance requirements. Upon receiving this request, the AMM initiates a comprehensive evaluation of the active AI model's output against these radio metrics, thereby determining whether the model should be reclassified as RADIO. By enforcing this evaluation process through the downlink AI provisioning request, the RAN node maintains a high degree of control over radio resource management and ensures that devices dynamically recalibrate their AI model classifications in response to real-time measurements of CQI, SINR, and other critical base metrics.

The device also manages AI model versions. When it receives multiple versions of the same AI model, it organizes the models into separate maps based on their priority. The device prioritizes higher-priority models and ensures that the active versions are selected for execution. If the priority of a newly received model is higher than that of an already active model, the device swaps the lower-priority model out of the map and replaces it with the new, higher-priority model. This model management process is dynamic and continuously adjusts the model deployment based on changing network conditions and the availability of resources.

Finally, the device periodically checks whether the AI model's activation restriction conditions are met. If the conditions are satisfied, the device proactively deactivates all active RADIO AI models and overrides any previously set triggering or exit conditions to ensure that the network resources are optimized for the current conditions. In addition, the device sends a status report to the RAN node, signaling the need for any required radio capability upgrades or relaxations. These requests may involve adjusting reference signal patterns, reducing the maximum allowable scheduling delay, or reconfiguring network parameters to maintain overall system performance and stability.

The categorization of AI models as “RADIO” or “non-RADIO” may be performed based on their relevance to radio performance metrics. The formula RADIO(Mi)RADIO(Mi) evaluates to 1 (RADIO) if the output of model Mᵢ either directly matches or exhibits a statistical correlation ρ exceeding a predefined threshold τ with any base radio metric B (e.g., SINR, CQI), where

$$ρ ( {M}_{i}^{output} , B )$$

quantifies the correlation strength between the model's predictions and the set B, and

$${M}_{i}^{output} ∩ B \neq ∅$$

tests for direct overlap between the model's output parameters and the base metrics. If neither condition is met, RADIO(Mᵢ) evaluates to 0 (non-RADIO). This dual-condition framework ensures models influencing or predicting radio-layer behavior are prioritized as RADIO, enabling dynamic resource allocation aligned with network performance requirements. The correlation threshold t is configurable to balance sensitivity and specificity, while BB evolves dynamically based on RAN-provided metrics, ensuring adaptability to changing network conditions.

$$RADIO ( {M}_{i} ) = \{ \begin{matrix}1 & if ρ ( {M}_{i}^{output} , B ) \geq τ or {M}_{i}^{output} ∩ B \neq ∅ < 0 \\ 0 & otherwise\end{matrix}$$

where ρ=correlation coefficient, B=set of base radio metrics, τ=correlation threshold.

The priority ranking mechanism for AI models is formalized as a weighted linear combination P(Mⱼ)=αvᵢ+βtᵢ, where P(Mⱼ) represents the computed priority score of model Mᵢ, vᵢ denotes the version number (a monotonically increasing integer reflecting model iterations), and it encodes the model type as a numerical weight derived from predefined categories (e.g., RADIO models assigned higher weights than non-RADIO types). The coefficients α and β are system-configurable scaling factors that determine the relative influence of versioning and model type on priority, enabling dynamic adaptation to network policies—for instance, prioritizing newer models (α>>βα>>β) or radio-critical operations (β>>αβ>>α). This equation underpins the compilation of primary/secondary model maps by ensuring higher-priority RADIO models (with elevated tᵢ values) and updated versions (larger vᵢ) dominate the active inference queue unless overridden by input availability or exit conditions. The weights titi directly map to enumerated types in the metadata (e.g., RADIO=0.8, VIDEO=0.3), while α and β are tuned to balance stability (favoring proven versions) against radio performance (favoring RADIO-type relevance), as mandated by the RAN's activation constraints and reporting rules.

$$P ( {M}_{i} ) = α {v}_{i} + β {t}_{i}$$

Where vᵢ=version number, tᵢ=type weight (RADIO>non-RADIO), α, β=metadata coefficients.

The activation criteria for AI models is established through the condition

$$Activate ( {M}_{i} ) ⇔ {S}_{c urrent} ∈ [ {S}_{min}^{i} , {S}_{max}^{i} ] ,$$

where S_{current} represents real-time measurements of a radio performance metric (e.g., SINR, SNR), and

$$[ {S}_{min}^{i} , {S}_{max}^{i} ] ,$$

defines model-specific activation bounds extracted from the metadata of model Mt. Metrics may be collected at the UE/WTRU side. The bidirectional implication (⇔) ensures activation occurs exclusively when S_{current} lies within the closed interval defined by

$${S}_{min}^{i} ( lower threshold )$$

and

$${S}_{max}^{i}$$

(upper uiresnoiu), wiu une pounds tailored to the model's operational purpose—for instance, restricting activation of a high-complexity model to optimal SINR ranges to ensure reliable inference. This inequality-based triggering mechanism dynamically couples model execution to network conditions, enabling context-aware resource allocation where models activate only when radio metrics satisfy their predefined viability ranges. The interval endpoints

$${S}_{min}^{i} and {S}_{max}^{i}$$

are derived from KAN-provided configurations or model metadata, ensuring alignment with network policies, while S_{current} is continuously updated via real-time radio layer measurements, creating an adaptive feedback loop between network state and AI model activation.

$$Activate ( {M}_{i} ) ⇔ {S}_{current} ∈ [ {S}_{min}^{i} , {S}_{max}^{i} ]$$

Where S=radio metric (e.g., SINR), S_{min/max}ⁱ=trigger bounds from metadata.

Each model downloaded at the device may essentially be trained for a certain performance region, whatever this is. Outside this, the model may not perform well because it may not be pretrained for this. Once a WTRU downloads a model, the WTRU may extract from metadata training or trigger regions such that outside of those regions, the WTRU may deactivate a mode. There may not be a single model that is suitable for all conditions at all times. Some metrics may essentially be at the RAN. For instance, a model at the WTRU may only work if uplink congestion seen by the RAN does not exceed certain threshold. The WTRU may be aware of such performance at the RAN and it may be free to decide whether it should deactivate the respective model or not. The RAN may be kept unaware proactively about those WTRU decisions until the devices triggers the proposed reporting.

Further, the exit condition for AI model deactivation is defined using the logical conjunction Exit (Mᵢ)⇔∧(k=1 to n) of

$$( {C}_{k} \geq {θ}_{k}^{i} ) ,$$

where Cₖ represents real-time measurements of n system parameters (e.g., battery capacity, computational load, thermal levels, device CPU loading, and expected user activity) and

$${θ}_{k}^{i}$$

denotes predefined threshold values for model Mᵢ), as specified in its metadata. The formula evaluates to true (triggering deactivation) only when all monitored parameters C₁, C₂, . . . , Cₙ simultaneously meet or exceed their respective thresholds

$${θ}_{1}^{i} , … , {θ}_{n}^{i}$$

ensuring comprehensive system safety and resource preservation. This universal quantifier-like structure (via the ∧ operator) enforces strict compliance across all exit criteria, preventing premature deactivation while safeguarding against single-point failures—for instance, requiring both low battery

$$( {C}_{battery} \geq {θ}_{battery}^{i} )$$

and high latency

$$( {C}_{latency} \geq {θ}_{latency}^{i} )$$

to half inference. Thresholds

$${θ}_{k}^{i}$$

are model-specific, enabling tailored resource management (e.g., stricter battery limits for power-intensive RADIO models), while Cₖ dynamically updates from device sensors, creating a closed-loop system that prioritizes operational integrity over sustained AI execution. The equation ensures deterministic, metadata-driven deactivation aligned with both device constraints and network sustainability goals.

$$Exit ( {M}_{i} ) ⇔ {∧}_{k = 1}^{n} ( {C}_{k} \geq {θ}_{k}^{i} )$$

Where Cₖ=system parameter (e.g., battery), θₖⁱ=exit thresholds for model Mᵢ

The model swapping protocol is thus governed through the optimization

$${M}_{swap} = arg {max}_{{M}_{j} ∈ S} P ( {M}_{j} ) \cdot δ ( input {s}_{j} ) ,$$

where M_{swap} identifies the optimal lower-priority model from the secondary map SS to replace a deactivated primary model. The function P(Mⱼ) represents the priority score from Equation 2, while δ(input sⱼ) acts as a binary indicator (0 or 1) verifying the availability of mandatory inputs for model Mⱼ. The argmax operator selects the candidate model that maximizes the product of these terms, ensuring prioritization of both metadata-defined importance P(Mⱼ) and operational feasibility (δ). This multiplicative formulation guarantees that only models with fully available inputs (δ=1) are eligible, preventing swaps to inoperable models while favoring higher-priority candidates when multiple viable options exist. For example, between two RADIO models in S, the one with newer versions (α vᵢ) or stronger type weights (β tᵢ,) prevails, provided its input requirements are met. The equation enforces efficient resource utilization by dynamically reconfiguring the primary map with minimal latency, ensuring continuity in radio-critical AI operations despite fluctuating input availability or exit-triggered deactivations.

$${M}_{swap} = arg {max}_{{M}_{j} ∈ S} ( P ( {M}_{j} ) \cdot δ ( input {s}_{j} ) )$$

Where S=secondary map, δ=input availability indicator.

Finally, the reporting logic of the AI model status is established through the condition Transmit⇔(t mod T=0)∨(ΔState≠0), where reporting is triggered either periodically at intervals T (when t mod T=0, i.e., time t is a multiple of T) or immediately upon detecting state transitions in RADIO models (when ΔState≠0), indicating activation/deactivation events). Here, t represents real-time system time, T is a configurable reporting periodicity parameter received from the RAN node, and ΔState quantifies changes in model states (e.g., transitions from active to inactive). The logical OR (∨) ensures reports are generated under either condition, combining scheduled updates with event-driven responsiveness. Periodic reporting guarantees baseline network synchronization, while state-triggered reporting minimizes latency for critical updates, such as sudden deactivations due to exit conditions or activation restrictions. The modulo operation (mod) enforces strict temporal alignment with T, reducing timing jitter, while ΔState is computed as a bitwise XOR of current and prior state vectors, detecting any deviation in active/inactive status across the primary map. This dual-mechanism optimizes signaling overhead by suppressing redundant reports during stable intervals while ensuring prompt notification of operational changes, aligning uplink signaling with dynamic RAN requirements and resource constraints.

$$Transmit ⇔ ( t mod T = 0 ) ⋁ ( Δ State \neq 0 )$$

Where T=reporting periodicity, ΔState=state transition event.

A method for managing on-device artificial intelligence (AI) models in a wireless device may comprise receiving, decoding and storing one or more AI models and associated metadata including a model identifier, version, and priority; receiving base radio metrics and activation restriction conditions, from a radio access network (RAN) node, wherein AI model status reporting is activated for AI models of prediction outputs which include and/or correlated to any of the said metrics; categorizing and marking a subset of the stored AI models as a ‘RADIO’ model on condition of the AI model output matches and/or is correlated to any of the received base metrics and as a non-RADIO model otherwise; determining for each AI model one or more activation triggers and exit conditions based on the associated metadata; compiling a first primary AI model map of highest priority RADIO models with their identifiers, versions, states, and associated triggers and exit conditions and a secondary second map of available lower priority RADIO models; monitoring and validating the availability of mandatory inputs and/or fulfillment of AI model exit conditions and swapping in a lower priority model from the secondary map for any primary model lacking required inputs and/or of a fulfilled one or more exit condition; transmitting, based on a preconfigured periodicity and/or an AI model in the primary map with a state transition from non-active to an active state and/or an AI model in the primary map with a state transition from an active to non-active state, a numerated list of determined RADIO AI model exit conditions including indications or numerated IDs for one or more associated exit conditions of all AI model in the primary AI model map, AI model status information including activated or deactivated model IDs and request indication of Radio capability relaxation or request indication of Radio capability upgrade; validating, and overriding model-specific triggers by, RAN node activation restrictions prior to executing AI model inference; and on condition of active coordinated multi-WTRU AI model interreference, transmitting an AI model exit indication, as part of side-link group control information, when deactivating Radio AI models associated with group applications.

The AI model and its associated metadata may be received as part of non-access stratum (NAS) downlink signaling, wherein the metadata includes a model ID, a model version, a priority indication of the current AI model, and/or an AI model type indication from a predefined set of enumerated model types as {(000, ‘VIDEO’), (001, ‘RADIO), (010, ‘NON-RADIO), (110, ‘VOICE), (001, ‘ENEREGY EFFICIENY’)}.

On a condition of a present AI model type indication contained in the metadata, the AI Model Manager determines a first functional categorization of the AI model and to selectively process the AI model in accordance with its designated type.

A RAN node may receive via downlink radio resource control (RRC) or downlink control information (DCI) signaling a set of one or more radio base metrics, wherein the radio base metrics may include, but not limited to, at least one of channel quality indicator (CQI), signal to interference noise ratio (SINR), signal to noise ratio (SNR), and reference signal received power (RRSP), and wherein the AI Model Manager (AMM) activates uplink control signaling-based status reporting for any active AI model whose output either directly matches or is correlated to any of the received base metrics, such that if an AI model outputs, for example, a predicted received downlink signal strength that serves as an input for calculating the SINR, that is configured as a base metric, the AMM designates the AI model as a RADIO model and mandates the activation of status reporting.

Upon receiving the AI model metadata, determining a first type of the AI model based on the AI model type indication contained therein, and receiving from a RAN node a set of radio base metric indications, wherein the AI model output is evaluated to determine if it matches or correlates to any of the configured base metrics, and wherein, upon a positive determination that the AI model output corresponds to one or more of the radio base metrics, the AI Model Manager overrides the initial AI model type determination and updates the AI model type to RADIO.

For each AI model, determining based on the received metadata one or more model triggering conditions and model exit conditions, wherein the model triggering conditions include predetermined criteria such as a specific SINR range for AI model inference activation and the model exit conditions include predetermined criteria such as a minimum battery capacity level threshold for AI model inference deactivation.

Compiling a first map of AI models determined to be categorized as or of type ‘RADIO’ models, wherein the first map comprises the AI model ID, the model version, the model state indicating active or inactive status, the model triggering conditions, and the model exit conditions.

On condition of receiving multiple versions of the same AI model identified by a common AI model ID, each version being associated with a respective model priority, compiling a second map of AI models determined to be categorized as or of type ‘RADIO’ models, wherein the second map contains the model information-including model ID, version, state, triggering conditions, and exit conditions—of the lower priority AI models, while a first map comprises the AI model information of the higher priority AI models.

Receiving a downlink signaling update associated with a specific AI model identified by a certain Model ID, the update including new metadata that comprises one or more different version information and corresponding priority level indications, and processing the update to adjust the mapping and management of the AI model in accordance with the revised version and priority information.

On condition of the AMM receiving and decoding a new AI model update with a model ID matching any of the stored AI model IDs, determining the updated AI model priority and, if the updated priority is higher than that of the AI model in the first AI model map, swapping the updated new model into the first AI model map in place of the existing higher priority AI model, and for the AI model in the second AI model map, overriding and/or overwriting the stored AI model with the higher priority level indication from the swapped AI model in the first map and the current AI model in the second map.

On the condition of the AMM receiving and decoding a new AI model update with a model ID matching any of the stored AI model IDs, determining the updated AI model priority, and in an alternative embodiment, ranking all received AI model versions associated with the same model ID and storing them in a set of AI model maps arranged according to their determined priority levels from highest to lowest.

On the condition of fulfilling one or more exit conditions of the higher priority AI model ID in the first map and/or determining the non-availability of any required inputs for the higher priority AI model ID in the first map, deactivating the higher priority AI model ID and checking whether another AI model with the same model ID exists in other passive AI model maps, on condition of determining a lower priority AI model with the same model ID as the higher priority model, determining its input availability and whether its triggering conditions are fulfilled based on current radio conditions, on condition of input availability and fulfilled triggering thresholds of the lower priority model, AMM swapping the lower priority AI model into the first map to replace the deactivated model.

Executing AI model inference for the higher priority AI models stored in the first compiled AI model map, wherein the inference execution is performed based on the availability of required inputs and the fulfillment of the corresponding triggering conditions.

On the condition of an active first AI model map containing active higher-priority AI models categorized as RADIO models, determining and compiling a numerated set of all possible exit conditions associated with the active AI models in the first map and transmitting the compiled exit conditions as uplink control information to the RAN node.

Receiving, via downlink signaling, one or more NAS signaling rules indicating AI model activation restriction conditions, wherein the restrictions include geolocation coordinates over which AI model activation is prohibited, service IDs for which AI model activation is restricted, and traffic flow bearer indications that limit AI model activation.

Checking and validating whether any of the associated AI model activation restriction conditions are satisfied, and on condition that one or more AI model activation restriction conditions are fulfilled, preemptively stopping and deactivating all active RADIO models in the first AI model map, overriding all AI model-specific triggering and exit conditions.

On the condition of an active AI model inference or non-active to active transition of a RADIO AI model in the first AI model map, transmitting an AI model status report to the RAN node, wherein the report indicates the active AI model ID and includes a request for radio capability relaxation, including adjustments such as stopping or reducing channel state information reference signal (CSI-RS) to a certain CSI-RS pattern indication, stopping or reducing phase tracking reference signal (PTRS) to a certain PTRS pattern indication, and increasing the maximum allowable scheduling delay to a certain scheduling delay level indication.

On the condition of a non-active AI model inference or active to non-active transition of a RADIO AI model in the first AI model map, transmitting an AI model update to the RAN node, wherein the update includes indications of the deactivated model IDs, one or more indications of the fulfilled exit conditions, and a request for radio capability upgrade, including starting or increasing channel state information reference signal (CSI-RS) to a certain CSI-RS pattern indication, starting or increasing phase tracking reference signal (PTRS) to a certain PTRS pattern indication, and reducing maximum allowable scheduling delay to a certain scheduling delay level indication.

On the condition of deactivating and/or transitioning a RADIO AI model from active to non-active state, wherein the AI model is associated a device-common application, compiling and transmitting an AI model exit indication over the side-link interface as part of the side-link control information group signaling, wherein the indication specifies that the AMM/WTRU is signing off from executing the indicated AI model ID.

A radio access network (RAN) node may comprise a transmitter that transmits control information comprising metadata and data including at least one AI model to a UE, wherein the metadata describes the model and includes a model id, version and priority; the transmitter further transmits radio metrics and activation restriction conditions to the UE, wherein AI model status reporting is activated for AI models of prediction outputs which include and/or are correlated to any of the said metrics; wherein based on the transmitted information, the UE performs: categorizing and marking a subset of the stored AI models as a ‘RADIO’ model on condition of the AI model output matches and/or is correlated to any of the received base metrics and as a non-RADIO model otherwise; determining for each AI model one or more activation triggers and exit conditions based on the associated metadata; compiling a first primary AI model map of highest priority RADIO models with their identifiers, versions, states, and associated triggers and exit conditions and a secondary second map of available lower priority RADIO models; monitoring and validating the availability of mandatory inputs and/or fulfillment of AI model exit conditions and swapping in a lower priority model from the secondary map for any primary model lacking required inputs and/or of a fulfilled one or more exit condition; transmitting, based on a preconfigured periodicity and/or an AI model in the primary map with a state transition from non-active to an active state and/or an AI model in the primary map with a state transition from an active to non-active state, a numerated list of determined RADIO AI model exit conditions including indications or numerated IDs for one or more associated exit conditions of all AI model in the primary AI model map, AI model status information including activated or deactivated model IDs and request indication of Radio capability relaxation or request indication of Radio capability upgrade; validating, and overriding model-specific triggers by, RAN node activation restrictions prior to executing AI model inference; and on condition of active coordinated multi-WTRU AI model interreference, transmitting an AI model exit indication, as part of side-link group control information, when deactivating Radio AI models associated with group applications.

A structure may include an AI manager of a WTRU/device that downloads various AI models from a third-party server or vendor, for various radio and non-radio functions. Examples can be for adjusting battery saving mode based on predicted user activity (non-radio), or for radio functions, for example, predicting near future received coverage level without the need for network assistance of additional reference signals. Some AI models may appear and may be decided as non-radio by the device, such as for instance, energy efficiency AI models that predict sleep duration of the device; however, that may for example collide with paging channels of device, and so, a device shall miss any potential pages, impacting its radio access performance. If a RAN node(s) are totally unaware about those models, that may cause an issue. In an embodiment, an objective is to allow a RAN node to control how devices run AI models specially those impacting any of the radio performance metrics. A device may also receive from RAN node some overall AI use restriction criteria when fulfilled, the device is mandated to shutdown all on board AI for instance, during certain critical times and/or locations and/or certain service activation where any AI model misbehaving is not tolerated. A device may build multiple maps of stored AI models, where a first map includes models, categorized by the device to be RADIO models (based on metadata or network enforcement as explained in examples herein), and those of a higher priority indication. A priority may imply that a vendor prefers this model since for instance it is trained for more wider radio conditions and takes more inputs that same model ID, but with a lower priority. A WTRU may build subsequent AI model maps because depending on real time conditions, input availability and exit conditions of each model, it may need to dynamically swap AI models among the maps and so, swaps execution of AI models in time depending on real time conditions. A WTRU may override its first determination of a non-radio model when RAN node enforces that a model that has an output of certain metrics and/or correlates to certain metrics must be categorized as RADIO and so, AI model status reporting may be activated such that RAN node tracks how well the RADIO AI models are actually working at devices. For this, the WTRU upon activating or deactivating a certain RADIO model, the WTRU may update the RAN with what happened to a model as well as if the device needs any radio capability adaptation due to such AI model status change. If an AI model on device is deactivated, and which used to predict packet generations ahead of actual packet generation, and so, the device used to tell RAN, e.g. X number of packets for resource allocation but without delay limitations since packets may not actually be generated. When such model is deactivated, a device may now require a maximum tolerable scheduling delay because it does not make such prediction gain anymore.

Grouping models as RADIO and non-Radio (and possibly overriding its determination if the RAN node requires certain provisioning on models that impacts certain radio performance KPIs, even of those determined by the device from model metadata, as non-radio), device building various priority-dependent AI model maps and tracks exit and triggering conditions of all are examples and other grouping methods may be applicable with the embodiments disclosed herein. Devices may transmit AI model status updates (periodically or event triggered) to the RAN on models that are determined to be RADIO related. Due to these model transitions, a device may require a change of its radio capability. For example, when a device transfers a lower priority model for interference estimation to execution while deactivating the same model but higher priority (due to for example, battery limits to un that more complex model), it now then may need more reference signal assistance from the RAN due to the low capability active model now. Such radio request may be triggered based on on-device AI applicability and status determination. WTRUs may store multiple models on board.

Wireless communication systems for future generations may be fundamentally AI native rather than merely AI capable. In these next-generation systems, artificial intelligence is integrated as an inherent component of the network architecture, with AI processing and data management embedded across all layers of radio operations. This integration mandates a complete redesign of conventional radio protocols and operations to accommodate and optimize the transmission, processing, and management of diverse AI data sets.

By transitioning to an AI native framework, the wireless network is reengineered to support not only conventional communication tasks but also the real-time processing of multi-modal AI data. This includes the seamless handling of large-scale, heterogeneous data streams that originate from or are destined for AI-driven applications. The redesigned radio operations incorporate adaptive, learning-based mechanisms that enable dynamic resource allocation, improved latency management, and enhanced throughput performance. These modifications ensure that future wireless networks can meet the stringent performance and reliability requirements imposed by advanced AI applications while maintaining efficient utilization of the radio spectrum.

US Patent Publication no. 20200089755 to Shazeer et al is disclosed herein by reference in its entirety. Shazeer focuses on the internal architecture of a machine learning system handling multi-modal data for improved learning outcomes. WO2024010399 to David Gutierrez Estevez et al. is disclosed herein by reference in its entirety. Gutierrez Estevez concentrates on the management of AI models within RANs, ensuring efficient operation and resource utilization. US Patent Publication no. 20220408282 to Zhang et al. is disclosed herein by reference in its entirety. Zhang describes that an AI protocol layer of a communication apparatus obtains AI data based on the AI parameter, encapsulates the AI data into a second AI protocol data unit AI PDU.

The following presents a simplified summary of the disclosed subject matter in order to provide a basic understanding of some of the various embodiments. This summary is not an extensive overview of the various embodiments. It is intended neither to identify or critical elements of the various embodiments nor to delineate the scope of the various embodiments. Its sole purpose is to present some concepts of the disclosure in a streamlined form as a prelude to the more detailed description that is presented later.

In one exemplary embodiment, the wireless transmit/receive unit (WTRU) receives AI multi-modal PDU set mapping configurations from the RAN node via downlink control information or radio resource control signaling, wherein each configuration entry associates a multi-bit index with a specific AI traffic type and its corresponding payload size range; the WTRU then utilizes these mappings to generate a structured uplink control information (UCI) message that concatenates the multi-bit indices and quantized payload size indications corresponding to uplink AI packet data unit (PDU) sets of various data set types, and dynamically excludes entries for components below a predefined threshold to compress the message and minimize signaling overhead.

In another exemplary embodiment, the WTRU operates by buffering AI PDU set components generated by an active AI application in a dedicated buffer that segregates AI data from non-AI data, calculating a remaining delay budget by subtracting the cumulative uplink transmission delay, AI processing delay at a core network entity, and downlink reception delay from a target delay budget, and triggering the transmission of the buffered AI PDU set when the remaining delay falls below a preconfigured maximum threshold; furthermore, if the buffered AI PDU set exceeds a defined maximum size, the WTRU segments the PDU set into one or more segments, appends a media access control (MAC) control element (CE) carrying the corresponding multi-bit indices and quantized size indications to each segment, and transmits the segments over granted uplink resources, ensuring that only corrupted segments are retransmitted based on hybrid automatic repeat request feedback.

In a further exemplary embodiment, the RAN node processes the received uplink control information (UCI) from the WTRU to reconstruct the structure of the transmitted AI PDU set by interpreting the concatenated sequence of multi-bit indices and associated quantized payload size values; the RAN node then prioritizes AI multi-modal traffic types based on predefined priority levels, allocates uplink resources accordingly-potentially preempting non-AI transmissions when the remaining delay budget falls below a critical threshold- and leverages segmentation counters and terminal flags included in each segment to ensure correct reassembly, while providing HARQ feedback for selective retransmission of corrupted segments to maintain overall system efficiency and prevent AI application outage.

In conventional 5G systems, packet data unit (PDU) set reporting is optimized for homogeneous data streams, where each PDU within the set carries similar types of payloads such as video frames or data packets that adhere to a unified quality-of-service profile. In these networks, the reporting mechanism aggregates information regarding packet counts, loss ratios, and decoding success for each PDU set, assuming that the content is uniform and that errors or delays impact the entire set in a predictable manner. This method effectively supports applications where the payloads are derived from a single data type, facilitating straightforward segmentation, retransmission, and overall error recovery processes.

By contrast, state of the art AI PDU sets generated by advanced AI applications encapsulate a heterogeneous mix of data types, including video, audio, metadata, and sensing data, all combined into a single integrated PDU set. The multi-modal nature of these AI-generated PDU sets presents significant challenges for conventional 5G PDU set reporting, as the uniform assumptions inherent in traditional reporting methods do not capture the nuanced performance metrics and diverse quality-of-service requirements across the different modalities. Consequently, a new reporting framework is required-one that can dynamically differentiate between the varied data streams, accurately assess delay budgets and packet loss for each individual modality, and provide tailored feedback to both the wireless transmit/receive unit and the RAN node to support the stringent performance demands of AI-native operations.

In an exemplary embodiment, an extended reality (XR) AI application generates a composite AI PDU set that simultaneously includes a high-resolution video frame, an audio frame, and metadata triggered by a user or device event. The generated AI PDU set consolidates these diverse data types into a single transmission unit, ensuring that all necessary information for rendering the XR scene is encapsulated and transmitted as a cohesive entity. Upon transmission from the wireless transmit/receive unit, the integrated PDU set is received by an IP Multimedia Subsystem (IMS) or an edge XR server, where it is processed to decode and integrate the video, audio, and metadata components into corresponding rendering data. In embodiments, a UE may receive from another UE in multi device collaboration scenarios including multi gamer XR, etc.

The compiled AI PDU set may be shared among a group of devices participating in an AI collaborative or coordinated application, such as a multi-player extended reality (XR) gaming environment. In such a scenario, the AI PDU of a given device contributes to the rendering of virtual objects at all collaborating devices, ensuring a consistent and synchronized user experience. The sharing of AI PDUs can be facilitated through the radio interface when an inter-device link is unavailable. In this case, the wireless transmit/receive unit (WTRU) includes one or more destination device identifiers within the uplink control information (UCI), enabling the radio access network (RAN) node to retransmit the received AI PDU toward the respective destination devices. Alternatively, if an inter-device link is available, the AI PDU is shared directly via the sidelink interface, wherein the sidelink control information (SCI) is used to indicate the AI PDU structure, traffic type, and intended recipient device.

In another exemplary embodiment, the system architecture is designed to guarantee that the complete two-way communication-encompassing the transmission of the composite AI PDU set, its rapid processing at the server, and the subsequent delivery of rendering data back to the device-occurs within a stringent delay budget. This delay threshold is critical for maintaining seamless user experience in XR applications, as any significant deviation could result in a missing or delayed rendering update, causing perceptible lag. By processing the heterogeneous content of the AI PDU set as a unified whole, both the server and the device collaboratively ensure that the resulting rendering data is generated and applied in real time, thereby preserving the interactive and immersive quality essential for advanced XR services.

The wireless transmit/receive unit (WTRU) receives from a radio access network (RAN) node a set of AI multi-modal PDU set mapping configurations via downlink control or radio resource control signaling. Each configuration entry in this set uniquely associates a multi-bit index with a specific AI multi-modal traffic type and, optionally, with a designated traffic type priority level. This mapping ensures that each type of AI data-such as video, audio, metadata, or sensor inputs—is correctly identified and aligned with its corresponding transmission parameters during PDU set compilation.

Simultaneously, the WTRU receives AI PDU set configurations that specify critical operational parameters, including a pre-configured maximum AI PDU set size and a pre-configured maximum remaining delay threshold. These parameters are helpful to the device's decision-making process, as they govern the timing and segmentation of the buffered AI data. The maximum AI PDU set size parameter determines the upper limit of data that can be aggregated into a single transmission unit, while the maximum remaining delay threshold ensures that the aggregated data is transmitted before the cumulative delay-arising from uplink scheduling, AI processing, and downlink reception-results in an application outage. This dual configuration framework enables the WTRU to efficiently manage and prioritize heterogeneous AI traffic, ensuring timely and reliable communication between the AI application and the network.

Further, the AI PDU set indices included in the signaling between the WTRU and the RAN node can be dynamically negotiated and determined based on the specific requirements of the AI application. This dynamic adaptation ensures that only relevant AI PDU set indices are included in the PDU mapping signaling, reducing unnecessary overhead. For example, for an AI application where no user interactions or human inputs are detected, pose information PDU set indices may be excluded from the set of available AI PDU set indices. By omitting such indices, the total number of AI PDU set mappings is reduced, leading to a reduction in signaling overhead while maintaining optimal transmission efficiency. This adaptability is particularly beneficial in scenarios where AI applications operate in different modes, allowing the network to allocate resources more effectively based on real-time application needs. The negotiation of AI PDU set indices may occur through radio resource control (RRC) signaling or downlink control information (DCI) signaling, enabling the WTRU to update its AI multi-modal PDU set mapping configurations dynamically as the AI application's operational state evolves.

TABLE 7
AI multi-modal PDU set mapping configurations
AI multi-modal PDU set mapping configurations

| | |
|---|---|
| AI PDU Set Index 001 | ‘VIDEO’ |
| AI PDU Set Index 002 | ‘SENSING DATA’ |
| AI PDU Set Index 003 | ‘AUDIO’ |
| AI PDU Set Index 004 | ‘POSE DATA’ |
| . | . |
| . | . |
| . | . |

Pre-configured maximum AI PDU set size
Pre-configured maximum remaining delay
threshold for AI PDU Set reporting trigger

In embodiments, an AI app may not use any (or at least some) data from user ‘humans, so a POSE data index may not be needed and that may reduce the number of bots needed to represent that index for this app without loss of performance.

Further, the AI multi-modal PDU set mapping configurations, received via downlink control information (DCI) or radio resource control (RRC) signaling, include a plurality of entries. Each configuration entry uniquely associates a distinct multi-bit index with a predefined AI multi-modal traffic type, including at least video data, audio data, and AI metadata. Each multi-bit index functions as a unique identifier that maps its corresponding traffic type to a specific payload structure during the AI PDU set compilation process.

The distinct mapping provided by the multi-bit indices enables the wireless transmit/receive unit (WTRU) to accurately segment and organize the diverse AI multi-modal data streams within the AI PDU set. As the AI application generates heterogeneous data elements, the multi-bit index facilitates the proper identification and alignment of each traffic type with its designated payload structure. This mapping ensures that the compilation process yields a well-structured AI PDU set, allowing subsequent processing by network nodes to efficiently decode, prioritize, and schedule the data for timely transmission, thereby maintaining the overall performance and reliability of the AI-native wireless system.

The AI multi-modal PDU set mapping configurations include, for each multi-bit index, a corresponding traffic type descriptor and a quantized payload size range. The traffic type descriptor provides an unambiguous identification of the AI multi-modal traffic type, such as video data, audio data, or AI metadata, thereby ensuring that each multi-bit index uniquely corresponds to a specific type of AI content. The quantized payload size range defines a set of discrete size values that represent the expected payload sizes for that traffic type. Together, these elements enable the WTRU to accurately interpret and organize heterogeneous AI data during PDU set compilation.

In a further exemplary embodiment, the WTRU generates the AI PDU set structure string by concatenating the multi-bit indices with the quantized size values derived from buffered AI multi-modal components. This concatenation forms a compact bitstring that clearly represents both the order and the size of the diverse data types contained within the PDU set, facilitating deterministic parsing by the network node. The resulting structure string not only ensures that the individual traffic types are correctly mapped to their corresponding payload structures but also supports efficient scheduling and processing of the AI data within stringent delay budgets required to maintain real-time application performance.

Furthermore, the AI multi-modal PDU set mapping configurations may include a default multi-bit index reserved specifically for unclassified AI traffic types. In this embodiment, if the WTRU encounters buffered AI multi-modal components that lack an explicit mapping configuration, the WTRU automatically assigns the default multi-bit index to those components. This assignment ensures that every AI data element is represented in the AI PDU set structure string, even when a specific mapping is absent. The default index remains in effect until updated mapping configurations are provided via downlink control information or radio resource control signaling, at which point the WTRU updates the assignment for any previously unclassified components accordingly.

The active AI application generates AI PDU set components comprising a plurality of AI multi-modal traffic types, such as video, audio, metadata, and sensor data, which are essential for the operation of AI-driven applications. These components are buffered within a dedicated storage area in the wireless transmit/receive unit, ensuring that they are isolated from non-AI data traffic. This segregation facilitates specialized processing and efficient handling of AI multi-modal data, enabling the device to maintain a streamlined pipeline for timely compilation and transmission of AI PDU sets.

Furthermore, by isolating the AI data in a dedicated buffer, the system can implement tailored delay management and resource allocation strategies that are specifically optimized for the heterogeneous nature of AI multi-modal traffic. The segregation not only enhances processing efficiency but also minimizes potential interference with conventional data flows, ensuring that critical AI information is processed in real time to meet the strict delay requirements of AI applications.

The dedicated buffer is implemented within the wireless transmit/receive unit to store AI multi-modal components generated by the active AI application. This buffer is architected to segregate AI data from conventional non-AI traffic, thereby enabling tailored delay management and resource allocation strategies optimized for the heterogeneous nature of AI data. The buffer supports dynamic prioritization by assigning higher priority to time-critical components-such as real-time video frames or sensor inputs-ensuring that these components are processed and transmitted with minimal delay. In addition, the buffer may incorporate mechanisms, such as timestamp-based aging, to automatically discard data that exceeds a predefined time-to-live threshold, thereby preventing stale information from adversely impacting AI application performance.

Further, the buffer design provides dynamic resource management capabilities that interact with uplink scheduling and local processing functions. The prioritization logic within the buffer continuously evaluates the remaining delay budget of each AI component, reordering the transmission queue to ensure that high-priority data is dispatched promptly to meet stringent latency requirements. This specialized handling not only reduces interference with conventional data flows but also facilitates the implementation of advanced segmentation and selective retransmission schemes, thereby maintaining the overall integrity and responsiveness of AI-native wireless communications.

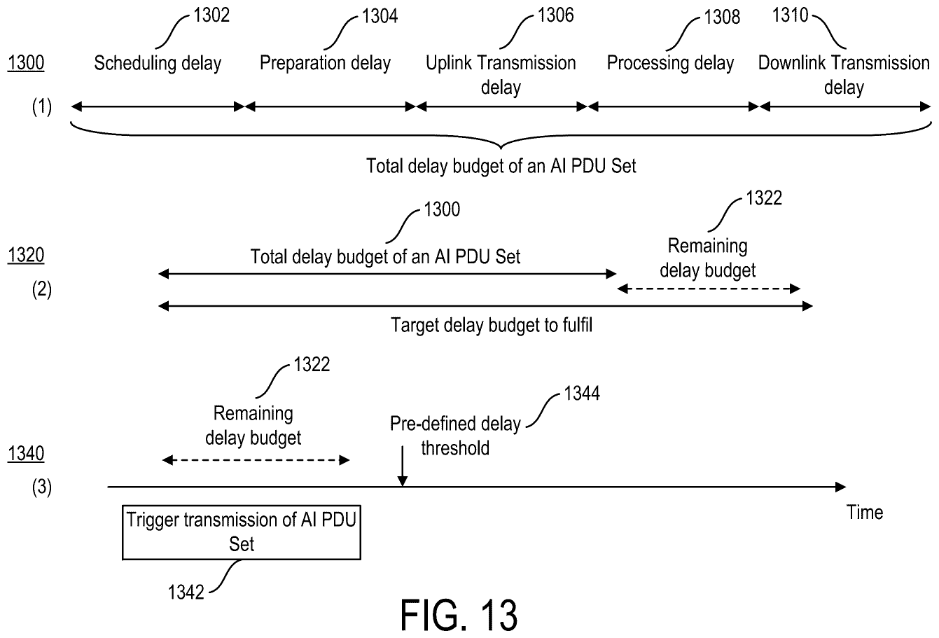

As shown by FIG. 13, the wireless transmit/receive unit (WTRU) calculates a remaining delay budget for an AI PDU set by dynamically subtracting a cumulative delay from a predefined target delay budget. The target delay budget represents the maximum tolerable end-to-end latency required to prevent an application outage and ensure seamless AI-driven interactions. The cumulative delay accounts for multiple latency components, including the uplink transmission delay incurred while transferring the AI PDU set to the network, the AI processing delay at the core network entity responsible for interpreting and generating an AI response, and the downlink reception delay experienced when delivering the AI-generated response back to the WTRU.

To ensure precise delay estimation, the WTRU continuously monitors network conditions and periodically updates the cumulative delay value based on real-time measurements and feedback from the radio access network (RAN). The calculated remaining delay budget is then used as a key decision metric to determine whether the AI PDU set should be transmitted immediately or whether further buffering is feasible without exceeding the delay constraints. This dynamic delay management mechanism enables the WTRU to optimize AI PDU set transmissions while adhering to strict quality-of-service (QoS) requirements necessary for AI-native applications.

The WTRU obtains the cumulative delay information required for AI PDU set transmission by leveraging signaling from the radio access network (RAN) node. Specifically, the AI processing delay introduced by an edge extended reality (XR) server can be directly provided by the RAN node, which dynamically monitors the server's processing load and associated latencies. This AI processing delay value is signaled to the WTRU, enabling it to incorporate the latest network conditions into its remaining delay budget calculations.

Furthermore, the AI processing delay value is continuously updated via downlink control information (DCI) signaling to reflect real-time network conditions. In scenarios where backhaul congestion or processing overload occurs at the edge XR server, the RAN node dynamically adjusts the reported AI processing delay, ensuring that the WTRU is aware of fluctuations in network responsiveness. By integrating these updated delay values into its computations, the WTRU can make informed decisions about whether to transmit an AI PDU set immediately or delay transmission to align with network capacity, thereby preventing application disruptions while optimizing uplink resource utilization.

Specifically, the WTRU continuously compares the delay budgets of AI multi-modal traffic with those of conventional data traffic to determine the optimal transmission schedule. For example, when the dedicated AI buffer holds a combination of high-resolution video frames, audio streams, and sensor metadata for an XR application, the WTRU calculates that the cumulative delay for these components is approaching, for example, 95 milliseconds out of a target delay budget of 100 milliseconds. In contrast, conventional data such as background file downloads stored in a separate buffer may operate with a delay threshold of 500 milliseconds. Recognizing the critical nature of the AI data for real-time rendering, the WTRU prioritizes the immediate transmission of the AI PDU set, while deferring the transmission of non-critical conventional traffic.

Specifically referring to FIG. 13, the total delay budget of an AI PDU set 1300 includes a scheduling delay 1302, preparation delay 1304, uplink transmission delay 1306, processing delay 1308 and or downlink transmission delay 1310. These delays (or estimates thereof) may be determined by a RAN node, WTRU, or other device and signaled therefrom.

The total delay budget to fulfill 1320 is comprised of the total delay budget of an AI PDU set 1300 plus a remaining delay budget 1322. Process 1340 shows that with a remaining delay budget 1322, transmission of an AI PDU set may be triggered 1342 before a pre-defined delay threshold 1344.

In another embodiment, the WTRU further evaluates the composition of its AI buffer, which might contain, for instance, five high-resolution video frames, three audio segments, and two metadata packets, with a total accumulated delay of 85 milliseconds. If the RAN node signals an increase in AI processing delay-perhaps due to a real time backhaul congestion—the device determines that waiting further could result in missing the stringent delay requirement necessary for smooth XR rendering. Consequently, the WTRU triggers transmission of the AI PDU set immediately, even if that requires partial transmission, ensuring that the most critical components are processed in real time. Meanwhile, conventional traffic with a higher permissible delay is scheduled later, thereby optimizing uplink resource allocation and maintaining the integrity of the user experience in AI-native applications.

The WTRU may employ a dedicated buffer that incorporates a timestamp-based aging mechanism to manage AI multi-modal components effectively. Each AI PDU set component, including video, audio, metadata, and sensing data, is assigned a timestamp upon arrival in the buffer, allowing the WTRU to track the duration each component remains stored before transmission. The WTRU continuously compares these timestamps against a predefined time-to-live (TTL) threshold, ensuring that outdated AI multi-modal components exceeding this limit are automatically discarded. This prevents stale or obsolete data from being transmitted, which could otherwise degrade AI application performance by introducing outdated or inconsistent information into the AI processing pipeline.

The WTRU employs a high-precision internal clock that is periodically synchronized with a network time reference to generate accurate timestamps. When an AI multi-modal component-such as a video frame, audio segment, metadata packet, or sensing data—is generated by or received from the AI application, the WTRU captures the current time from its internal clock and assigns this value as the timestamp to the component as it enters the dedicated buffer. This mechanism ensures that every AI PDU set component is tagged with a uniform and precise time marker, enabling the system to accurately monitor its age relative to the predefined time-to-live threshold.

In another embodiment, the WTRU may also leverage temporal metadata provided by the AI application, adjusting these externally sourced timestamps by incorporating known processing delays to yield an effective arrival time. This adjusted timestamp reflects the true buffering duration of the component and allows for fine-grained aging analysis. Furthermore, the WTRU periodically recalibrates its internal clock using network-provided time signals, thereby mitigating potential clock drift and ensuring that timestamp assignments remain consistent and reliable over extended operational periods.

By implementing this timestamp-based aging mechanism, the WTRU optimizes uplink resource utilization by prioritizing the transmission of fresh AI data while discarding expired components that no longer contribute to meaningful AI processing. This approach is particularly critical for real-time AI-driven applications, such as extended reality (XR) and autonomous systems, where stale data can compromise synchronization and degrade user experience. Additionally, the TTL-based mechanism reduces unnecessary network congestion by ensuring that only relevant, up-to-date AI PDU sets are transmitted, thereby enhancing overall system efficiency and maintaining the integrity of AI-driven interactions.

The WTRU triggers the transmission of the AI PDU set upon determining that the remaining delay budget has been reduced to or fallen below a pre-configured maximum remaining delay threshold. The WTRU continuously monitors the cumulative delay, which includes the uplink transmission latency, AI processing delay at the core network or edge server, and the downlink reception delay of the AI application response. As the AI PDU set remains buffered, the WTRU dynamically updates the remaining delay budget by subtracting the cumulative delay from the target delay budget, ensuring real-time tracking of the time constraints imposed by the AI-driven application.

The WTRU may further delay the triggering of AI PDU set transmission until all buffered components of a synchronized multi-modal frame are available in the dedicated buffer. This ensures that AI-driven applications, such as extended reality (XR), receive a complete set of AI multi-modal traffic types, including video, audio, metadata, and sensing data, in a single transmission, preserving synchronization and preventing data inconsistencies during AI processing at the network entity. The WTRU monitors the arrival of each AI multi-modal component and determines whether the full AI PDU set has been compiled before initiating uplink transmission. By waiting for all required components to be buffered, the WTRU enhances data integrity and ensures the network receives fully structured AI PDU sets for efficient processing and response generation.

However, when the remaining delay budget for any individual AI PDU set component falls below the pre-configured threshold, the WTRU prioritizes partial transmission to prevent service outage or application degradation. In such cases, the WTRU transmits the available AI multi-modal components without waiting for the full synchronized frame, ensuring that the most time-sensitive AI data reaches the network entity within the allowable delay constraints. This dynamic transmission strategy enables real-time AI-driven applications to function reliably by balancing the need for synchronized data delivery with the urgency of preventing excessive delays that could disrupt AI processing, rendering, or decision-making. Through this selective transmission approach, the WTRU optimally manages AI PDU set delivery while adapting to varying network conditions and application constraints.

WTRU may dynamically override non-AI uplink scheduling grants when the remaining delay budget for an AI PDU set falls below a critical threshold specified in the AI PDU set configurations. The WTRU continuously monitors the cumulative delay associated with uplink transmission, AI processing at the network entity, and downlink reception of AI application responses. When the remaining delay budget reaches the critical threshold, the WTRU prioritizes the transmission of AI PDU sets by preempting non-AI data traffic, ensuring that AI-driven applications maintain their strict latency requirements. This mechanism enables the WTRU to allocate uplink resources preferentially for AI data, preventing service degradation caused by excessive transmission delays.

By enforcing AI PDU set prioritization, the WTRU ensures that time-sensitive AI multi-modal data, including video, audio, and metadata components, are transmitted with minimal delay, reducing the risk of missing application deadlines. The WTRU coordinates with the radio access network (RAN) node to request expedited uplink resource grants when preemption is required, facilitating the rapid transmission of AI data while temporarily deferring lower-priority traffic. This dynamic uplink scheduling adjustment ensures that AI-native applications, such as extended reality (XR) and autonomous systems, operate seamlessly without lag or service interruptions. The ability to override non-AI uplink scheduling grants allows the network to adapt to real-time AI workload demands, ensuring an optimal balance between AI and conventional data transmission while preserving user experience and application performance.

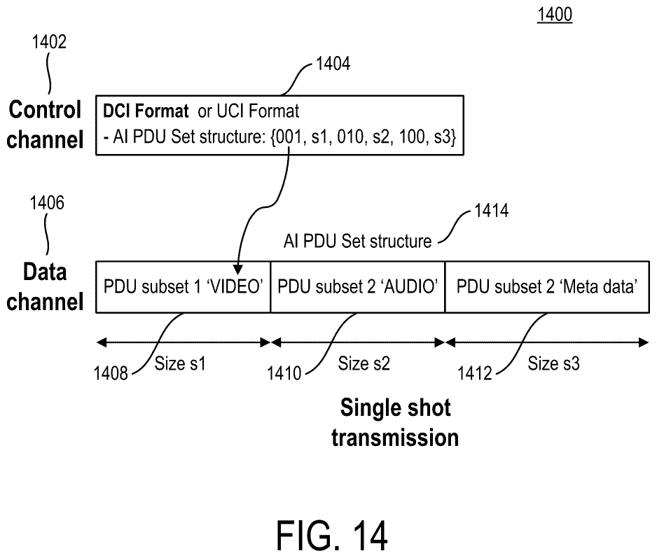

FIG. 14 is an illustration 1400 of uplink PDU control information transmission alongside PDU Set delivery over an uplink data channel 1402. As shown by FIG. 14, the WTRU generates and transmits an uplink control information (UCI) format 1404 to the serving radio access network (RAN) node, providing critical metadata regarding the structure of the AI PDU set 1414. In the example shown, a data channel 1406 is used to transmit the AI PDU set 1414 comprising a VIDEO PDU subset 1408, AUDIO PDU subset 1410 and a metadata PDU subset 1412.

The UCI format includes AI PDU set structure information, specifying one or more AI multi-modal traffic types present in the AI PDU set along with their corresponding AI payload size indications. The WTRU compiles this information by extracting multi-modal traffic type identifiers and quantized size values from the buffered AI PDU set components, ensuring that the RAN node has precise knowledge of the AI data characteristics before scheduling uplink transmission. By transmitting this structural information in the UCI, the WTRU enables the RAN node to optimize resource allocation, prioritizing the transmission of AI data components based on network conditions and application-specific latency constraints.

As part of the UCI transmission process, the WTRU encodes the AI PDU set structure in a format that allows efficient parsing by the RAN node, ensuring minimal signaling overhead while maximizing the accuracy of AI traffic type representation. The UCI format dynamically adapts to the real-time AI traffic composition, including various modalities such as video, audio, metadata, and sensor data, ensuring that the RAN node can apply appropriate transmission and processing policies based on the received AI multi-modal structure. Additionally, the WTRU may dynamically adjust the level of detail in the UCI format based on predefined network configurations, selectively including or omitting certain AI multi-modal traffic type indications to optimize signaling efficiency while still enabling effective scheduling. By leveraging this UCI-based AI PDU set reporting, the network ensures precise coordination between the WTRU and the RAN node, allowing AI-native applications to maintain stringent quality-of-service (QoS) requirements while maximizing network resource utilization.

In one exemplary embodiment, the UCI format dynamically prioritizes high-priority AI traffic types such as high-resolution video frames and real-time audio streams. These modalities, which are critical for interactive and immersive applications like extended reality (XR) or augmented reality (AR), are encoded with detailed traffic type indications and payload size values to ensure that the RAN node allocates sufficient resources for timely transmission. The fine-grained representation of video and audio data facilitates immediate processing, thereby preserving the real-time performance and quality-of-service (QoS) requirements of the AI-native application.

In another embodiment, less time-sensitive AI traffic types such as sensor data or certain types of metadata may be selectively omitted or compressed in the UCI format. For instance, if sensor readings or auxiliary metadata contribute minimally to the immediate rendering of a virtual scene, the WTRU may choose to exclude these indications when their payload sizes fall below a predefined threshold. This selective omission reduces signaling overhead while still preserving the essential information needed for overall system coordination. Additionally, when the AI application operates in a non-interactive mode, dynamic inputs such as pose information or user gesture data may be aggregated or omitted, thereby further optimizing the uplink resource utilization without compromising critical performance parameters.

Thus, the UCI format is designed to dynamically change based on the specific AI requirements of the user equipment (UE). The WTRU adapts the level of detail in the UCI format according to the current AI application context, such as the number, type, and priority of AI multi-modal traffic elements present. When high-priority AI data like real-time video and audio are active, the UCI is expanded to include detailed multi-bit indices and quantized payload size fields. In contrast, if the AI application requires only a minimal set of modalities, extraneous information is omitted, thereby reducing signaling overhead and conserving uplink resources.

Further, a variable-size UCI format is designed to flexibly encode AI PDU set control information according to the specific data composition and priority levels of the AI traffic. When high-priority video data is present, the UCI allocates additional bits for payload size quantization, thereby enabling a high-precision representation of the video payload's size. Conversely, for lower-priority metadata that does not directly impact rendering quality or AI prediction, fewer bits are utilized for size quantization, thus reducing the overall signaling overhead. This dynamic allocation allows the UCI to carry more bits at one instance when the precision requirement is high and fewer bits at another instance, depending on the real-time AI traffic composition.

To ensure that the RAN node can accurately decode this variable-size UCI, the device may include an indication of the quantization level for each high-priority payload, specifying the number of bits used for its size field before the full UCI payload is decoded. Alternatively, the RAN node may employ conventional blind decoding techniques to parse the UCI structure. Additionally, when transmitted over shared uplink resource sets with other AI-capable devices, the UCI may be scrambled using a user-specific scrambling code to prevent cross-device interference and ensure secure, efficient communication.

In an additional exemplary embodiment, the WTRU dynamically adjusts the uplink control information (UCI) format by selectively omitting AI multi-modal traffic type indications for AI PDU traffic components that fall below a predefined size threshold. This threshold is specified in the AI PDU set configurations, ensuring that the reporting mechanism remains efficient while preserving essential traffic information. By compressing the AI PDU set structure string, the WTRU reduces the number of bits required to encode the UCI, thereby minimizing uplink signaling overhead and conserving radio resources. The omission of indices and size fields for smaller AI multi-modal traffic components streamlines the transmission process, allowing the RAN node to efficiently parse the remaining AI PDU set structure information without unnecessary data overhead.

To ensure accurate reconstruction of the AI PDU set structure at the network side, the WTRU applies predefined encoding rules that maintain consistency in the UCI format even when certain AI traffic type indicators are excluded. The RAN node interprets the compressed structure string based on the size threshold configuration, ensuring that all relevant AI PDU components above the threshold are properly scheduled and transmitted while disregarding minor data fragments that do not significantly impact AI application performance. The dynamic exclusion mechanism allows the WTRU to adapt its UCI reporting based on real-time network conditions and AI traffic composition, ensuring that critical multi-modal AI components receive prioritized processing and transmission while non-essential data is efficiently managed. This approach optimizes the balance between signaling efficiency and AI PDU transmission accuracy, enabling AI-native applications to meet stringent latency and resource constraints in next-generation wireless networks.

The WTRU constructs the uplink control information (UCI) format by organizing AI multi-modal traffic type and size indications within the structure string according to traffic type priority levels established in the AI multi-modal PDU set mapping configurations. The WTRU assigns higher priority AI multi-modal traffic types a preferential position in the structure string, ensuring that critical AI PDU components, such as real-time video frames or low-latency haptic feedback, are scheduled and transmitted before lower-priority components like supplementary metadata. This prioritization mechanism allows the RAN node to process AI PDU sets in an order that aligns with application and network latency requirements, reducing the risk of performance degradation caused by delayed transmission of high-priority AI components.

To implement this prioritization, the WTRU sorts AI multi-modal traffic type indices and their associated payload size indications within the UCI format, ensuring that essential AI data elements are explicitly positioned at the beginning of the structure string for immediate recognition by the RAN node. The RAN node, upon receiving the UCI, interprets the priority-ordered structure string to allocate uplink resources accordingly, granting transmission opportunities to higher-priority AI PDU set components before lower-priority data is processed. This ensures that time-sensitive AI-driven tasks, such as rendering for extended reality (XR) applications, maintain synchronization with user actions while secondary AI processing tasks are accommodated within the remaining available resources. By dynamically structuring the UCI format based on AI traffic priority, the WTRU enhances network efficiency and guarantees that AI-native applications meet stringent real-time communication requirements in advanced wireless systems.

The WTRU generates the uplink control information (UCI) format with a variable-length field dedicated to the AI PDU set structure string indication, allowing for efficient and adaptive representation of AI multi-modal traffic components. The WTRU calculates a length indicator based on the number of real-time AI multi-modal components currently buffered in the AI PDU set, ensuring that the structure string dynamically scales to the actual AI data composition at the time of transmission. By prefixing the AI PDU set structure string with this length indicator, the WTRU enables deterministic parsing by the RAN node, allowing the network to efficiently extract and interpret AI multi-modal traffic type identifiers and associated size values without unnecessary processing overhead.

To optimize network efficiency, the WTRU adjusts the structure string's length in response to real-time AI application demands, ensuring that only relevant AI traffic type and size indications are included in the UCI transmission. This prevents unnecessary signaling overhead while maintaining complete visibility into AI PDU set composition for the RAN node. Upon reception of the UCI, the RAN node uses the prefixed length indicator to parse the structure string without ambiguity, allowing rapid and efficient resource allocation for AI PDU set transmission. The use of a variable-length structure string ensures scalability for AI-native wireless systems, accommodating dynamic AI-driven workloads while minimizing unnecessary control signaling, thereby enhancing the overall efficiency of AI-based data transmission in next-generation networks.

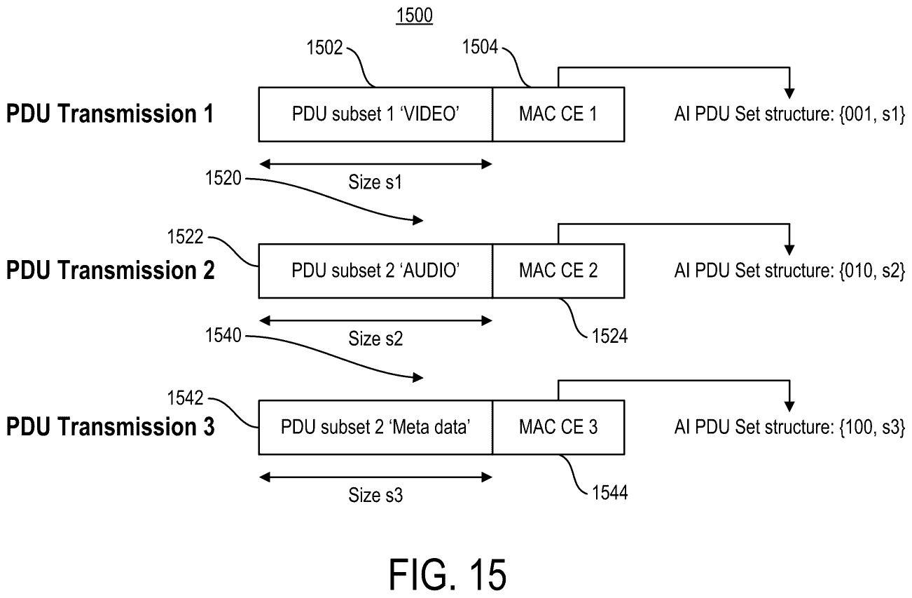

FIG. 15 depicts that when the buffered AI PDU set exceeds a pre-configured maximum AI PDU set size, the WTRU initiates segmentation, dividing the AI PDU set into one or more segments while ensuring that each segment contains at least one AI multi-modal traffic type. The segmentation process follows AI PDU set configurations that define the structuring of AI data based on traffic type priorities and latency requirements, allowing efficient handling of diverse AI-driven workloads. Each generated segment is then appended with a media access control (MAC) control element (CE), which provides critical metadata for segment identification and prioritization. The MAC CE includes one or more multi-bit indices that explicitly indicate the AI multi-modal traffic types present in the segment, enabling the RAN node to correctly interpret and process the segmented AI data without ambiguity.

The segmentation mechanism ensures that AI PDU sets, which inherently carry a combination of video, audio, metadata, and sensor data, are optimally managed to prevent buffer overflow while maintaining transmission efficiency. By embedding the multi-bit indices in the MAC CE, the WTRU allows the RAN node to reconstruct the AI PDU set structure without requiring deep packet inspection or additional control signaling. This approach minimizes processing delays at the network side, supporting AI-native wireless communication where real-time AI data delivery is critical. Furthermore, segmentation facilitates more flexible scheduling of AI traffic, allowing high-priority AI components to be allocated resources preferentially, while lower-priority traffic types can be scheduled accordingly to optimize overall network efficiency. The segmentation process, combined with the MAC CE, enhances the adaptability of AI data transmission in next-generation networks, ensuring seamless AI-driven experiences while meeting stringent latency and quality-of-service requirements.

Segmentation of the AI PDU set may be, in one embodiment, performed based on traffic type priority levels as defined in the AI multi-modal PDU set mapping configurations, ensuring that high-priority AI traffic types are isolated into standalone segments while lower-priority traffic types may be grouped together. The WTRU identifies the priority levels of each AI multi-modal component and applies segmentation rules that prevent high-priority traffic from being delayed due to the presence of lower-priority data within the same segment. To facilitate efficient prioritization by the network, each segment is appended with a MAC control element (MAC CE) that explicitly flags the priority level of the included AI multi-modal traffic types. The MAC CE metadata ensures that the RAN node can parse the received segments and allocate uplink resources accordingly, prioritizing the transmission of high-priority segments to maintain stringent latency and reliability requirements.

By explicitly tagging the priority level within the MAC CE, the method enables AI-native traffic management in which critical AI components, such as real-time video frames in extended reality (XR) applications or low-latency AI inference data, are given transmission precedence over less time-sensitive data. This ensures that essential AI-driven experiences, including XR rendering, autonomous control, or AI-assisted communication, maintain uninterrupted performance without degradation caused by network congestion. Additionally, the segmentation mechanism provides adaptability to dynamic network conditions, allowing the RAN node to adjust scheduling policies based on congestion levels, available resources, and ongoing AI service demands. The ability to isolate high-priority AI data into dedicated segments while signaling their importance via MAC CE enhances the efficiency of AI PDU set transmission, optimizing end-to-end latency while maintaining the integrity of AI-native wireless communications.

Furthermore, the WTRU segments the AI PDU set into one or more segments, and each segment is appended with a media access control (MAC) control element (CE) that contains a header field indicating the total number of AI multi-modal traffic types present within the segment. This header field is immediately followed by a sequence of multi-bit indices, each corresponding to a particular AI traffic type, and by corresponding payload size indications that denote the quantized sizes of the AI data components. This structured inclusion of indices and payload sizes enables the RAN node to accurately reconstruct the original AI PDU set structure without the need to fully decode the entire payload, thereby streamlining the processing and reducing the computational load on the network.

By incorporating this detailed metadata into the MAC CE, the method facilitates efficient interpretation of the segmented AI PDU set at the RAN node. The explicit header field and subsequent sequence of multi-bit indices with size indications allow the network to rapidly determine the composition and organization of the transmitted AI multi-modal traffic. Consequently, the RAN node can implement optimized scheduling and resource allocation strategies based on the reconstructed PDU set structure, ensuring that critical AI data is processed with the requisite priority while maintaining overall system efficiency and reducing latency in AI-native wireless communications.

Specifically, referring to FIG. 15, shows three PDUs 1500, 1520, 1540. PDU 1500 has a ‘video’ PDU subset 1502 and an appended MAC CE 1504. PDU 1520 has an ‘audio’ PDU subset 1522 and an appended MAC CE 1524. PDU 1540 has a PDU ‘meta data’ subset 1542 and an appended MAC CE 1544.

In an additional exemplary embodiment, the method further comprises embedding a segmentation counter within the MAC control element (CE) appended to each segment of a fragmented AI PDU set. The segmentation counter is incremented for each successive segment, thereby providing an ordered sequence that indicates the position of each segment within the overall AI PDU set. Additionally, a terminal flag is included in the MAC CE to explicitly indicate the final segment of the fragmented AI PDU set. This arrangement allows the RAN node to reassemble the AI PDU set losslessly, even if the individual segments are received out of order, by using the segmentation counter to determine the correct sequence and the terminal flag to verify the completion of the set.

After segmenting the AI PDU set, the WTRU employs a retransmission mechanism based on hybrid automatic repeat request (HARQ) feedback from the RAN node. The HARQ feedback identifies which segments of the AI PDU set were received without error and which were corrupted during transmission. The WTRU selectively retransmits only the segments that are confirmed to be in error, thereby conserving uplink resources and minimizing additional latency by avoiding unnecessary retransmission of segments that have been successfully received.

In another exemplary embodiment, while the WTRU initiates retransmission of the corrupted segments, the AI entity processes the uncorrupted segments immediately. This approach allows the AI entity to continue its operations and generate timely responses even if portions of the AI PDU set are still pending complete reception. By handling uncorrupted segments without delay, the system ensures that it meets the target delay budget required to prevent application outages, maintaining real-time performance despite partial retransmissions.

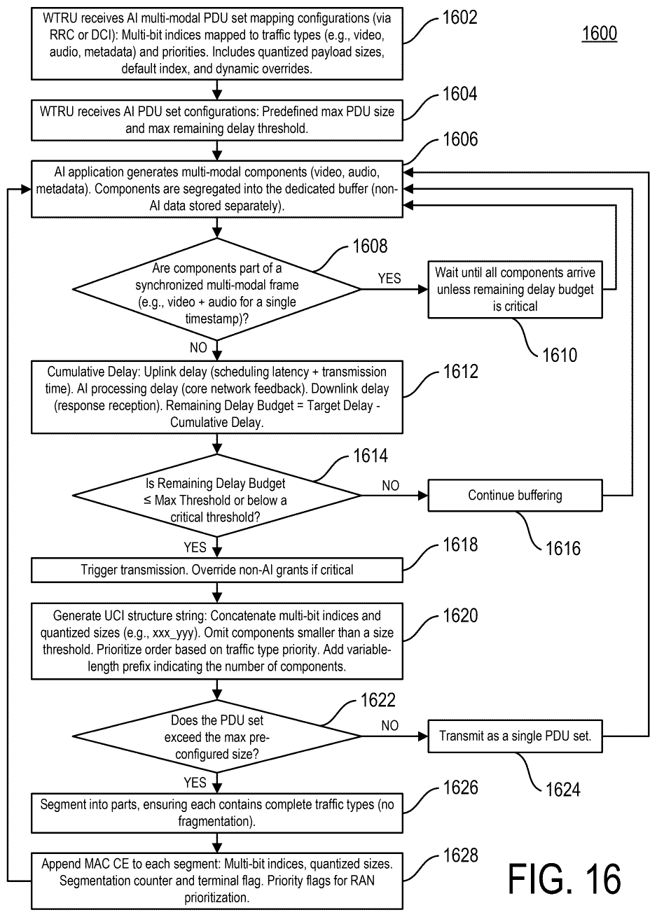

FIG. 16 illustrates an overall flow chart 1600 of the method for managing AI multi-modal PDU set transmission in an AI-native wireless system. At the outset, the wireless transmit/receive unit (WTRU) receives 1602 AI multi-modal PDU set mapping configurations and AI PDU set configurations 1604 from the radio access network (RAN) node via downlink control or radio resource control signaling. These configurations include multi-bit indices that uniquely associate distinct AI traffic types and their priority levels, as well as parameters specifying the maximum AI PDU set size and the maximum remaining delay threshold. Following this, the WTRU buffers 1606 AI PDU set components-comprising diverse data types such as video, audio, metadata, and sensing data-generated by the active AI application into a dedicated buffer that segregates AI data from non-AI traffic.

The WTRU determines whether components are part of a synchronized multi-modal frame 1608 and if so, the WTRU may wait 1610. If not, the WTRU calculates a remaining delay budget by subtracting the cumulative delay 1612, which includes uplink transmission delay, AI processing delay at a core network or edge server, and downlink reception delay, from a target delay budget that is critical to preventing application outage. When the remaining delay budget falls below the pre-configured threshold 1614, the WTRU triggers the transmission 1618 of the AI PDU set, overriding non-AI uplink scheduling grants if necessary to allocate resources for timely delivery, otherwise continues buffering 1616. At this stage, the WTRU generates an uplink control information (UCI) message 1620 that encapsulates the structure of the AI PDU set by including AI multi-modal traffic type and payload size indications derived from the buffered components.

If the aggregated AI PDU set exceeds the maximum allowable size 1622, the WTRU segments 1626 the set into one or more segments, each containing at least one complete AI multi-modal traffic type, otherwise it transmits 1624 as a single PDU set. Each segment is appended 1628 with a media access control (MAC) control element (CE) that comprises a header field indicating the total number of AI multi-modal traffic types in the segment, followed by a sequence of multi-bit indices and corresponding payload size indications. In addition, the MAC CE embeds a segmentation counter that increments for each successive segment and a terminal flag that denotes the final segment, thus ensuring lossless reassembly at the RAN node even if segments are received out of order.

Following transmission, the WTRU utilizes hybrid automatic repeat request (HARQ) feedback from the RAN node to identify any corrupted segments. Only those segments are retransmitted, while uncorrupted segments are immediately processed by the AI entity to meet the strict target delay budget. This flow chart provides a comprehensive view of the method's detailed steps—from configuration reception, buffering, and delay computation to transmission triggering, segmentation, UCI generation, and selective retransmission-all of which are designed to support the robust and timely delivery of heterogeneous AI multi-modal data in advanced wireless communication systems.

A method implemented by a wireless transmit/receive unit (WTRU) for managing transmission of artificial intelligence (AI) multi-modal packet data unit (PDU) sets, the method may comprise: receiving, from a radio access network (RAN) node: AI multi-modal PDU set mapping configurations, wherein each configuration entry associates a multi-bit index with a distinct AI multi-modal traffic type and/or traffic type priority level; and AI PDU set configurations specifying a pre-configured maximum AI PDU set size and a pre-configured maximum remaining delay threshold; buffering AI PDU set components generated by the active AI application in a dedicated buffer, wherein the AI PDU set components comprise a plurality of AI multi-modal traffic types and are segregated from non-AI data; calculating a remaining delay budget for the AI PDU set by subtracting a cumulative delay, associated with uplink transmission, AI processing at the core network entity, and downlink reception of an AI application response, from a target delay budget required to prevent application outage; triggering transmission of the AI PDU set upon determining that the remaining delay budget is less than or equal to the pre-configured maximum remaining delay threshold; generating and transmitting an uplink control information (UCI) format to the serving RAN node, the UCI format including: AI PDU Set structure information in terms of one or more AI multi-modal traffic type and AI payload size indications; transmitting the buffered AI PDU sets over granted uplink resources in accordance with the AI PDU set structure information provided in the UCI format; and segmenting the AI PDU set into one or more segments, each comprising at least one AI multi-modal traffic type, and appending a media access control (MAC) control element (CE) to each segment, wherein the MAC CE includes one or more multi-bit indices indicating the AI multi-modal traffic types in the segment, on condition the buffered AI PDU set exceeding the pre-configured maximum AI PDU set size.

The AI multi-modal PDU set mapping configurations received via downlink control information (DCI) or radio resource control (RRC) signaling may include entries associating distinct multi-bit indices with predefined AI multi-modal traffic types, including at least video data, audio data, and AI metadata, wherein each multi-bit index defines a unique identifier for mapping a corresponding traffic type to a payload structure during AI PDU set compilation.

The AI multi-modal PDU set mapping configurations may include, for each multi-bit index, a corresponding traffic type descriptor and a quantized payload size range, enabling the WTRU to generate the AI PDU set structure string by concatenating multi-bit indices and quantized size values derived from buffered AI multi-modal components.

The AI multi-modal PDU set mapping configurations may include a default multi-bit index for unclassified AI traffic types, and wherein the WTRU assigns the default index to buffered AI multi-modal components lacking explicit mapping configuration until updated mappings are provided via DCI or RRC signaling.

The AI multi-modal PDU set mapping configurations may be received via DCI signaling as a dynamic override to preconfigured RRC-based mappings, and wherein the AI PDU set configurations are semi-statically updated via RRC signaling to enforce network-wide consistency in AI PDU set size and delay thresholds across multiple WTRUs.

The dedicated buffer implements a timestamp-based aging mechanism, wherein AI multi-modal components exceeding a predefined time-to-live (TTL) threshold are automatically erased from the buffer to prevent stale data transmission and conserve uplink resources.

The target delay budget may be determined dynamically based on application-specific requirements received from the RAN node via RRC signaling, wherein the WTRU adjusts the target delay budget during active AI application sessions to reflect real-time quality-of-service (QoS) constraints negotiated between the AI-run application and the network.

The cumulative delay may be estimated by summing the uplink transmission delay derived including the uplink scheduling latency, an AI processing delay provided by the AI processing core network entity, and a downlink reception delay, wherein the WTRU periodically refines the estimate using feedback from the RAN node.

The WTRU may further delay triggering transmission of the AI PDU set until all buffered components of a synchronized multi-modal frame are available in the buffer, unless the remaining delay budget for any component falls below the pre-configured threshold, in which case partial transmission is prioritized to prevent outage.

Triggering transmission of AI PDU Sets includes overriding non-AI uplink scheduling grants when the remaining delay budget is below a critical threshold defined in the AI PDU set configurations, preempting non-AI data to allocate resources for the AI PDU set transmission.

The AI PDU set structure information in the UCI format comprises a concatenated sequence of multi-bit indices corresponding to AI multi-modal traffic types and associated quantized payload size values, formatted as a bitstring {xxx_yyy, . . . }, where “xxx” represents the multi-bit index from the mapping configurations of an AI multi-modal traffic type and “yyy” represents a quantized size indication value derived by dividing the actual payload size by a network-configured quantization step.

The UCI format may dynamically exclude AI multi-modal traffic type indications for AI PDU traffic components smaller than a predefined size threshold specified in the AI PDU set configurations, compressing the structure string by omitting corresponding indices and size fields to reduce UCI overhead.

The UCI format may prioritize the order of AI multi-modal traffic type and size indications within the structure string based on traffic type priority levels defined in the AI multi-modal PDU set mapping configurations, by scheduling and transmitting the respective AI PDU Sets, associated with higher priority AI multi-modal traffic types before ones associated with a lower priority traffic types, ensuring high-priority components are listed first for RAN node processing prioritization.

The UCI format may include a variable-length field for the AI PDU set structure string indication, prefixed with a length indicator calculated from the number of real-time AI multi-modal components in the buffered PDU set, ensuring deterministic parsing by the RAN node.

Segmenting the AI PDU set may include partitioning the buffered components such that each segment contains a complete instance of at least one AI multi-modal traffic type, avoiding fragmentation of individual traffic type components across segments, and wherein the appended MAC CE further includes a quantized size indicator for each traffic type within the segment to enable RAN node processing prioritization.

Segmentation may be performed according to traffic type priority levels defined in the AI multi-modal PDU set mapping configurations, such that high-priority traffic types are isolated into standalone segments, and the MAC CE explicitly flags priority levels to ensure preferential treatment during uplink resource allocation by the RAN node.

The MAC CE may include a header field indicating the total number of AI multi-modal traffic types within the segment, followed by a sequence of multi-bit indices and corresponding payload size indications, enabling the RAN node to reconstruct the original AI PDU set structure without decoding the entire payload.

In embodiments, a segmentation counter may be embedded in the MAC CE, the counter incremented for each successive segment of a fragmented AI PDU set, and a terminal flag indicating the final segment, ensuring lossless reassembly at the RAN node despite out-of-order delivery.

The WTRU retransmits only corrupted segments of the AI PDU set identified via hybrid automatic repeat request (HARQ) feedback from the RAN node, while uncorrupted segments are processed immediately by the AI entity to meet the target delay budget despite partial retransmissions.

What is claimed is:

1. A method performed by a wireless transmit/receive unit (WTRU) for dynamically performing two-stage artificial intelligence (AI) handover event predictions, comprising:
transmitting, to a serving radio access network (RAN) node, local handover information, as part of uplink control information (UCI), including a handover prediction information object;
receiving, from the serving RAN node one or more handover event AI prediction configurations;
executing a multi-layer AI prediction approach comprising:
executing a coarse-grained first prediction to identify potential handover events over a first long prediction period; and
executing a fine-grained second prediction to refine the timing and accuracy of the predicted handover events over a second shorter prediction period.

2. A method for managing on-device artificial intelligence (AI) models in a wireless device, the method comprising:
receiving one or more AI models and associated metadata including a model identifier, version, and priority;
receiving base radio metrics and activation restriction conditions, from a radio access network (RAN) node;
categorizing and marking a subset of the stored AI models as a ‘RADIO’ model;
determining for each AI model one or more activation triggers and exit conditions based on the associated metadata.

3. A method implemented by a wireless transmit/receive unit (WTRU) for managing transmission of artificial intelligence (AI) multi-modal packet data unit (PDU) sets, the method comprising:
receiving, from a radio access network (RAN) node: AI multi-modal PDU set mapping configurations, wherein each configuration entry associates a multi-bit index with a distinct AI multi-modal traffic type and/or traffic type priority level; and AI PDU set configurations specifying a pre-configured maximum AI PDU set size and a pre-configured maximum remaining delay threshold.
